(19) United States
(12) Patent Application Publication
(10) Pub. No.: US 2006/0277103 A1
(43) Pub. Date: Dec. 7, 2006

(54) Systems and methods for personalized product promotion

(75) Inventors: Minoru Fujita, Kobe-shi (JP); Ryoko P. Murotani, Toyama (JP)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: Magee, LLC, Lakewood, CO (US)

(21) Appl. No.: 11/430,405

(22) Filed: May 9, 2006

Related U.S. Application Data
(60) Provisional application No. 60/679,131, filed on May 9, 2005.

(30) Foreign Application Priority Data
Jan. 26, 2005 (JP) 2005-018893

(51) Int. Cl. G06Q 30/00

(52) U.S. Cl. 705/14

(57) ABSTRACT

Embodiments generally relate to systems and methods for personalized product promotion and pricing. More specifically, embodiments relate to systems and methods for providing customized retail customer treatment through the use of personalized promotions, which may include personalized coupons, rewards, deals, and the like. In some embodiments, the retailers' customers are assigned unique accounts. One or more promotions may be offered to selected customers based on customer information. Customer information can be obtained from customer activity which is monitored through the use of the unique account assigned to the customer. Personalized product promotion systems and methods enable a retailer to target individual users uniquely and allow for each customer to take advantage of customized promotions based on his/her activities.

### CROSS-REFERENCE TO RELATED APPLICATIONS

This application claims the benefit of Provisional Application No. 60/679,131, filed on May 9, 2005, which is hereby incorporated by reference for all purposes.

### TECHNICAL FIELD

Various embodiments of the present invention generally relate to systems and methods for personalized product promotion and pricing. More specifically, embodiments of the systems and methods provide for customized product pricing based on customer buying history.

### BACKGROUND

In order to increase profits, companies are continually identifying and implementing new techniques to increase sales. This is particularly, although not exclusively, true of the retail industry. One such method has been the “Customer Loyalty” program. A loyalty program is a program designed to keep customers by rewarding them with incentives or other benefits for remaining customers. A typical loyalty program rewards “loyal” customers by offering these customers better prices on a specific set of products. Unfortunately, the set of products are often selected for discount without regard to characteristics of the customers.

These types of “retail oriented” customer loyalty programs typically promote to a group of customers. In these programs, there are generally two types of customers, those in the program and those who are not. Typically, a customer enrolls in the program to get the “best” sales promotions. These promotions are offered to the entire group of program members as a single unit. As such, all customers within the program are treated the same and there is no sense of individuality in such a program. This type of program is meant to encourage customer loyalty and purchases with the retailer, which in theory should ultimately result in increased sales. One limitation with these types of rewards is that since the discount must be offered to the entire group, the discounts may not be as generous or provided for a wide variety of products.

In addition, when retailers use this type of mass strategy where promotions are sent to entire groups of customers without much, if any, attempt to customize the promotions to individual customers, the retailers are not targeting customers individually. For example, the retailers may send out the same promotion via mail, e-mail, fax, other electronic distribution, and/or the like to everyone within the customer database. In some instances, the retailer may randomly select a subset of the customers within the database. However, retailers are unable to offer rewards in a fashion that targets the promotional offer to individual customers based on determined or perceived preferences of the individual customer. One consequence of this is that customers may not obtain rewards that the customers value, and therefore may not be as loyal as the retailer would like.

### BRIEF SUMMARY

Embodiments of systems and methods described herein relate to personalized product promotion. More specifically, embodiments of the systems and methods enable customized retail customer treatment through the use of personalized promotions, each of which are offered to selected customers based on an association of a promoted product with the selected customers. Some embodiments generate one or more personalized promotional offers directed at a customer based on an associated customer profile that is determined, at least in part, from determined customer product preferences.

In accordance with various embodiments of the present invention, systems and methods are provided which enable retail establishments to provide personalized targeted rewards to their customers. Some examples of retail establishments which may benefit from this type of system include, but are not limited to, grocery stores, clothing stores, music stores, electronics stores, and the like. Furthermore, other embodiments allow for the use of personalized targeted rewards within individual departments within the retail establishment.

In some embodiments, the retailers' customers are assigned unique accounts. The retailers are then able to use the customer's individual account to monitor purchases. Based on the data collected for these purchases, the retailers are able to build customer profiles and build reward programs in which the rewards will be tailored to each individual customers. As such, personal pricing systems and methods enable a retailer to target and promote each individual user uniquely. Each customer may have different prices and rewards based on his/her activities. Thus, embodiments include functionality for personal pricing and mechanisms that permit personalized promotional offers and rewards for customers.

One embodiment includes a customer management system designed for use in the retail industry. The customer management system can receive customer input from point-of-sale kiosks and offer the customer personalized prices related to products that the customer is likely to purchase. The customer management system may also present a game to the user, wherein the game can be played at the kiosk, and includes icons associated with products the customer would likely purchase. A personalized price can be generated based on the outcome of the game. In accordance with some embodiments, the kiosks may also be configured to provide store maps, to assist the customer in locating products, and to provide a price checking feature.

In one embodiment, the retailer is able to track the use of the rewards offered to the customer. This information may then be used to further refine the customer profile or to generate improved marketing and promotions in the future.

This summary provides only a general outline of some embodiments of the present invention. Many additional objects, features, advantages and other embodiments of the present invention will become more fully apparent from the following detailed description, the appended claims and the accompanying drawings. As such, a more complete understanding of various embodiments of the present invention may be derived by referring to the detailed description of preferred embodiments and claims when considered in connection with the figures.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is an example of a computer system which may be utilized by various embodiments of the present invention;

FIG. 2 illustrates an exemplary high level logical diagram of a personal pricing system architecture in accordance with one embodiment of the present invention;

FIG. 3 represents an exemplary intermediate level block diagram of various components of the personal pricing system described in FIG. 2 in accordance with one embodiment of the present invention;

FIG. 4 is a flow diagram representing an exemplary method of determining the personalized promotional offers and rewards which may be available to an individual customer in accordance with one embodiment of the present invention;

FIG. 5 illustrates an simple exemplary product matrix which may be used in accordance with one embodiment of the present invention;

FIG. 6 represents a simple exemplary customer profile which may be used in accordance with various embodiments of the present invention;

FIG. 7 illustrates an exemplary login screen to a user interface of a promotional receiving center which may be used in accordance with one embodiment of the present invention;

FIG. 8 illustrates an exemplary personal pricing system maintenance portal main page which may be used in accordance with one embodiment of the present invention;

FIG. 9 is a flow diagram illustrating exemplary steps in a process of creating personal pricing promotions in accordance with one embodiment of the present invention;

FIG. 10 represents an exemplary user interface which may be used by an administrator to set up an Automatic Markdown promotion which may be used in accordance with one embodiment of the present invention;

FIG. 11 represents an exemplary administrative user interface which allows the initialization of a Table Pricing promotion in accordance with one embodiment of the present invention;

FIG. 12 represents an exemplary administrative user interface which allows an administrator to configure a Quantity Reward promotion in accordance with one embodiment of the present invention;

FIG. 13 represents an exemplary user interface which may be used by an administrator to set up a Sale Threshold promotion in accordance with one embodiment of the present invention;

FIG. 14 represents an exemplary user interface which may be used by an administrator to set up a Coupon Reward promotion in accordance with one embodiment of the present invention;

FIG. 15 represents an exemplary user interface which may be used by an administrator to set up a Weight Threshold promotion in accordance with one embodiment of the present invention;

FIG. 16 represents an exemplary user interface which may be used by an administrator to set up an End Of Sale (EOS) Table Pricing promotion in accordance with one embodiment of the present invention;

FIG. 17 illustrates an exemplary Item Explorer interface which may be used to locate products or add new products to the personal pricing system in accordance with one embodiment of the present invention;

FIG. 18 represents an exemplary Item Settings page that may be displayed after an item is selected or created in accordance with one embodiment of the present invention;

FIG. 19 illustrates an exemplary Item Promotion Link page which may be used in accordance with one embodiment of the present invention;

FIG. 20 illustrates an exemplary Item Promotion Admin screen which may be used in accordance with one embodiment of the present invention;

FIG. 21 represents an exemplary Advertisements maintenance screen which may be used in accordance with various embodiments of the present invention;

FIG. 22 illustrates an exemplary Games page which may be used in accordance with various embodiments of the present invention;

FIG. 23 illustrates an exemplary slot machine configuration page which may be used in accordance with various embodiments of the present invention;

FIG. 24 illustrates an exemplary Personal Pricing System Kiosk display advertisement which may be displayed during idle periods in accordance with various embodiments of the present invention;

FIG. 25 illustrates an exemplary screen which may be displayed when a kiosk screen is touched requiring the customer to enter their customer number;

FIG. 26 illustrates an exemplary customer screen which may be used in accordance with various embodiments of the present invention;

FIG. 27 represents an exemplary screen in which a customer is able to view the available games in accordance with various embodiments of the present invention;

FIG. 28 represents an exemplary slot machine game which is ready for play by the customer which may be used in accordance with various embodiments of the present invention;

FIG. 29 represents an exemplary screen shot of a slot machine game which has been played by the customer which may be used in accordance with various embodiments of the present invention;

FIG. 30 represents an exemplary Prize page which may be used in accordance with various embodiments of the present invention;

FIG. 31 represents an exemplary Customer Selection screen which may be used in accordance with various embodiments of the present invention;

FIG. 32 represents an exemplary Customer Promotions screen which may be used in accordance with various embodiments of the present invention;

FIG. 33 represents an exemplary screen shot of the notification of a Personal Pricing reward for a specific item which may be used in accordance with various embodiments of the present invention; and

FIG. 34 illustrates an exemplary screen shot of the default item information screen which may be used in accordance with various embodiments of the present invention.

### DETAILED DESCRIPTION

Various embodiments of the present invention generally relate to systems and methods for personalized product promotion and pricing. More specifically, embodiments of the present invention relate to systems and methods for providing customized retail customer treatment through the use of personalized promotions, coupons, rewards, deals, and the like.

In some embodiments, the retailers' customers are assigned unique accounts. Various rewards may be distributed to these customers based on customer activity monitored through the use of the unique account assigned to the customer. Embodiments of the personal pricing systems and methods enable a retailer to target and promote each individual user uniquely and allow for each customer to have different prices and rewards based on his/her activities. Thus, embodiments include functionality for personal pricing and mechanisms that facilitate the development and distribution of personalized promotional offers and rewards for customers.

Various embodiments of the present invention relate to a personal pricing system for targeting customers in an individual fashion with customer-specific promotions, rewards, and prices. Embodiments are applicable to numerous commercial settings, such as, but not limited to, grocery stores, department stores, and specialty stores. One or more embodiments of personal pricing systems and processes are described herein for illustrative purposes, and are not intended to the limit the scope of the invention. Furthermore, in the following description, for the purposes of explanation, numerous specific details are set forth in order to provide a thorough understanding of embodiments of the present invention. It will be apparent, however, to one skilled in the art that embodiments of the present invention may be practiced without some of these specific details.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a readable modem or network connection).

While, for convenience, embodiments of the present invention are described in the context of a grocery store, the present invention is equally applicable to various other retail environments in which various methods and apparatus described may be used. For example, embodiments of the present invention are thought to have applications to clothing stores, electronic stores, music stores, individual departments within each retail establishment, and the like.

Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection on with another. Based on the disclosure provided herein, one of ordinary skill in the art will appreciate a variety of ways in which connection or coupling exists in accordance with the aforementioned definition.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The term “product” refers to products (e.g., goods and merchandise) and services, which may be produced by a company and/or offered for sale to a customer.

A “promotion” or “product promotion” is an association between a product and a reward. The reward may relate to the product and/or another product(s). For example, the reward may be a discount on the price of the promoted product referenced in the promotion. As another example, the reward may be a discount on the price of another referenced product when the promoted product is purchased. Product price discounts may take many forms. For example, the discounted price may be a sale threshold discount, a quantity reward, automatic markdown in price, weight threshold discount, based on table pricing, and the like.

The phrase “promotional offer” generally refers to an offer for sale of a product or products referenced by a promotion. A promotional offer may be triggered by one or more events or activities such as the use of a coupon, purchase of a certain number of items, purchase of a certain weight of an item, purchase of certain types of items, playing of a game at a terminal, and the like. In addition, the phrase “promotional offer” may include all categories of promotional offers such as personalized promotional offers described below.

The phrase “personalized promotional offer” generally refers to a promotional offer which has been targeted to a selected customer, based, at least in part, on customer information. In one embodiment, the customer information includes customer purchase information. Customer purchase information may include product preference data, which may be obtained from the customer's purchasing history. As such, customer product information could identify products purchased in the past, amount of a product purchased in a specified time frame, whether at least a specified quantity has been purchased at any given time, and the like. As another example, a personalized promotional offer may be based on a customer profile which was developed by creating an item profile of each item for sale and using this item profile along with the purchases made by the customer to determine the customer profile. Then, the customer profile is used to determine if the promotional offer is a good fit for the customer. In another embodiment, the customer information includes preferences and characteristics selected by the customer.

The phrase “unique customer identifier” generally refers to anything that uniquely identifies a customer. In some cases a unique customer identifier is a alpha-numeric string of letters, characters, and/or numbers which may be used to identify the user. According to one embodiment, a unique customer identifier may be the user's telephone number. In another embodiment, a unique identification number may be an e-mail address. Yet still, in another embodiment, a unique customer identifier may be generated, randomly or systematically, by the entity which will use the number for identifying the user. In yet another embodiment, a customer's identifier can be generated by or correspond to a biometric parameter of the customer, such as a fingerprint, iris signature, handwriting signature, and so on.

The phrase “registered customer” generally refers to a customer who has signed up to participate in a customer loyalty program. According to one embodiment, the customer may pay to join the customer loyalty program. In another embodiment, the registration may be free. In addition, according to some embodiments, once a customer has registered with the customer loyalty program a unique customer identifier may be associated with the customer.

The phrase “non-registered customer” generally refers to a customer who has not signed up to participate in a customer loyalty program.

If the specification states a component or feature “may”, “can”, “could”, or “might” be included or have a characteristic, that particular component or feature is not required to be included or have the characteristic.

Exemplary System Overview

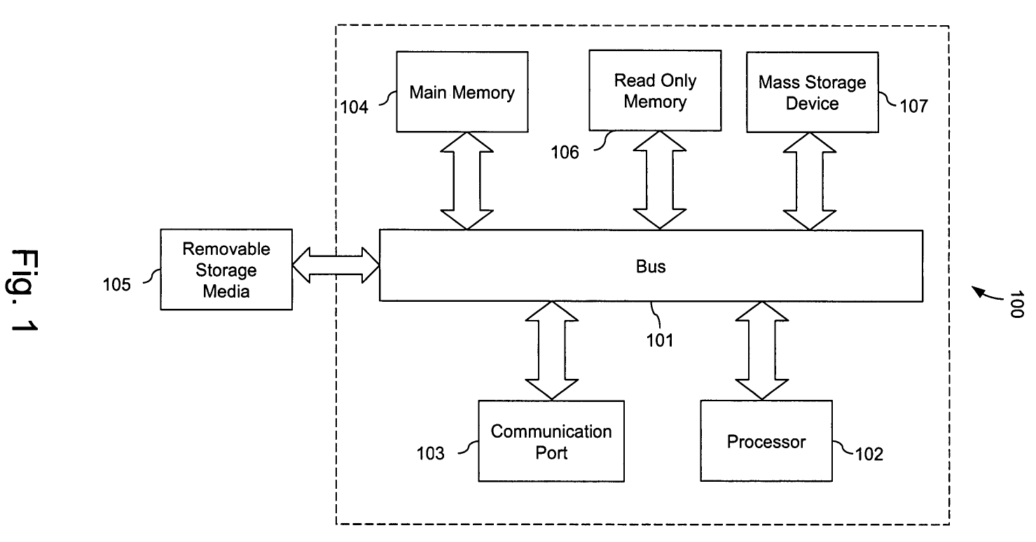

Embodiments of the present invention include various steps, which will be described in more detail below. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 1 is an example of a computer system 100 with which embodiments of the present invention may be utilized. According to the present example, the computer system includes a bus 101, at least one processor 102, at least one communication port 103, a main memory 104, a removable storage media 105 a read only memory 106, and a mass storage 107.

Processor(s) 102 can be any know processor, such as, but not limited to, an Intel® Itanium® or Itanium 2® processor(s), or AMD® Opteron® or Athlon MP® processor(s), or Motorola® lines of processors. Communication port(s) 103 can be any of an RS-232 port for use with a modem based dialup connection, a 10/100 Ethernet port, or a Gigabit port using copper or fiber. Communication port(s) 103 may be chosen depending on a network such a Local Area Network (LAN), Wide Area Network (WAN), or any network to which the computer system 100 connects.

Main memory 104 can be Random Access Memory (RAM), or any other dynamic storage device(s) commonly known in the art. Read only memory 106 can be any static storage device(s) such as Programmable Read Only Memory (PROM) chips for storing static information such as instructions for processor 102.

Mass storage 107 can be used to store information and instructions. For example, hard disks such as the Adaptec® family of SCSI drives, an optical disc, an array of disks such as RAID, such as the Adaptec family of RAID drives, or any other mass storage devices may be used.

Bus 101 communicatively couples processor(s) 102 with the other memory, storage and communication blocks. Bus 101 can be a PCI/PCI-X or SCSI based system bus depending on the storage devices used.

Removable storage media 105 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

The components described above are meant to exemplify some types of possibilities. In no way should the aforementioned examples limit the scope of the invention, as they are only exemplary embodiments.

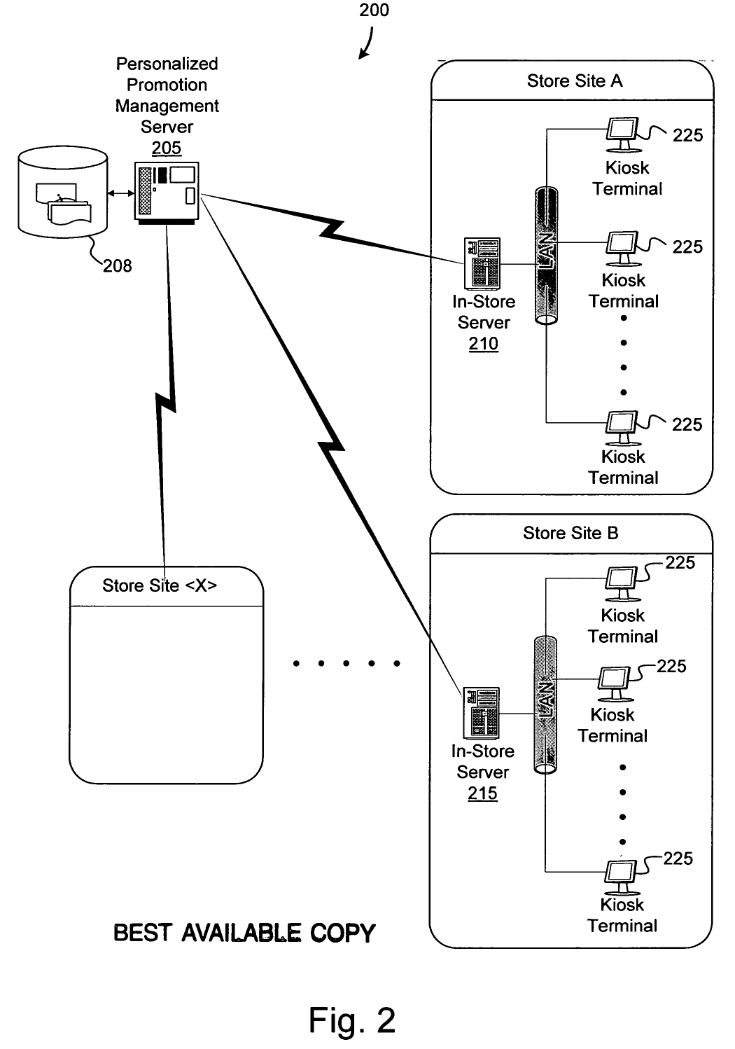

FIG. 2 illustrates an exemplary high level logical diagram of a personal pricing system architecture in accordance with one embodiment of the present invention. In the embodiment depicted, the personal pricing system is a customer management software system for the retail industry. The personal pricing system 200 can be logically divided into three major components: personalized pricing management server 205, one or more in-store systems 210, 215, and 220, each located at a store site, and one or more customer information kiosk terminals 225. Retailers and/or stores are typically clients of the personalized pricing management server 205.

In this particular embodiment, all of the store sites correspond to a single retailer (e.g., Safeway®). In actual operation, numerous different retailers, each potentially having multiple store sites could use the services of the personalized pricing management server 205. When multiple retailers are clients of the personalized pricing management server 205, each retailer may be identified by an associated retailer identifier and will typically have secure access to client-available services of the personalized pricing management server 205. Thus, for example, a personal pricing administrator for a retailer could log into the personalized pricing management server 205 with a retailer ID and password in order to add, change, or remove personalized product promotion and pricing options or information associated with that retailer or store site.

Personalized pricing management database 208 includes information for carrying out personalized product promotion and pricing. For example, the database 208 can include a configuration 209 for each retailer and/or store site. Thus, multiple configurations 209 could exist for each retailer—one for each store site. Data in the database may be formatted in any number of ways, such as, but not limited to, flat files, or relational data. Server 205 may include a structured query language (SQL) front-end interface through which administrators may access data in the database 208.

Although a single database 208 and personalized pricing management server 205 are illustrated, it will be understood by those skilled in the art that multiple servers and/or databases may be used. For example one or more servers could be associated with each retailer. As another example, multiple databases 208 could be used.

According to one embodiment, the personalized pricing management server 205 provides the client (the retailers) access into the personal pricing system. The personalized pricing management server 205 operates as an Application Service Provider (ASP). The personalized pricing management server 205 and infrastructure can be deployed, operated and maintained by a corporation independent of the retailer. According to one embodiment, authorized clients (the retailers) access the personalized pricing management server 205 through a web portal via the Internet. Using the web interface, the retailers have the ability to maintain and evaluate the operation of their configuration of the personal pricing system. In one embodiment, all the information regarding the configuration of the entire personal pricing system is contained at personalized pricing management server 205 site. The one or more in-store systems 210, 215, and 220 are communicably coupled to personalized pricing management server 205. Thus, changes to associated configuration(s) 209 are automatically distributed from the personalized pricing management server 205 to one or more appropriate in-store systems 210, 215, and 220. This may be done, for example, using a Wide Area Network (WAN) infrastructure.

In one embodiment, the in-store system of the personal pricing system can reside in the retailer's location. In one embodiment, in-store system software is installed on a computer within the retailer's location. The in-store system contains configuration information that is specific to only one of the local store site 210, 215, or 220. In some embodiments, there is no user access to this information directly at this level and modifications to this information are made at the personalized pricing management server 205. Once modifications to the information are made, the changes are then allowed to automatically flow down to the in-store location.

As described in more detail below, the in-store system can also interface to the retailer's point-of-sale system (not shown). This interface may be used to obtain and transfer accurate pricing information along with current sales, promotion or reward information used by the personal pricing system 200 to the point-of-sale system.

A third component of the personal pricing system is the customer information kiosk terminal 225. In accordance with one embodiment, free standing computer terminals 225 may be provided at the local store locations 210, 215, and 220 which may be used to provide an interaction point for customers. Another embodiment of the present invention provides for the terminal to be equipped with a touch screen interface. In yet another embodiment, store customers are able to interact with the personal pricing system 200 via a personal computer which is not located inside the local store site. For example, the personal computers may be located at the customer's home, at a library, or anyplace else which allows the personal computer to communicably couple with the personal pricing system 200, say for example via the internet. According to one embodiment, a customer, or a retail establishment, is able to set a language preference in which communications will be made through kiosk 225. Examples of possible languages include, but are not limited to, English, French, German, Japanese, Chinese, Spanish, and the like.

All customers will be able to use kiosk terminals 225 to obtain information about the retailer, the store location, item information, etc. In one embodiment, unregistered users are able to create temporary identification numbers in order to access some promotions and various features offered through kiosk terminals 225. However, the members in the retailer's customer loyalty program will have additional options and personalized promotions based on their purchase history and/or customer profile. Using the kiosks 225, for example, program members will be able to view their current profile, sales promotions and rewards, and participate in special tasks that provide a mechanism to obtain additional promotions or rewards which will be described in more detail below.

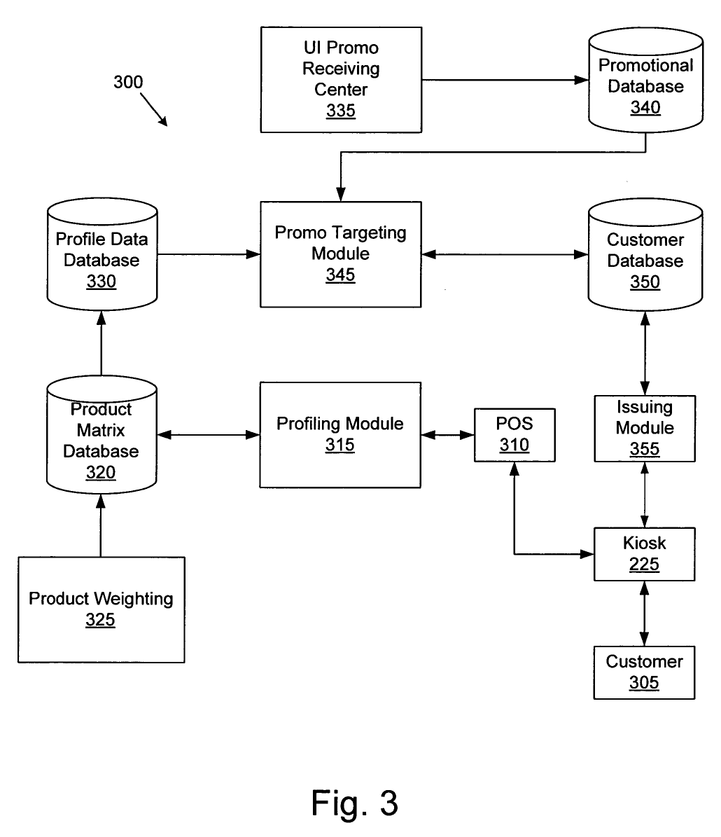

FIG. 3 represents an exemplary intermediate level block diagram of various components of the personal pricing system 200 described in FIG. 2 in accordance with one embodiment of the present invention. As previously mentioned, customer 305 is able to interact in various ways with a kiosk terminal 225. By using kiosks 225, or accessing the system through a personal computer remotely located from the store, various rewards, promotions, personalized promotional offers, and/or other types of special offers and advertisements may be viewed, and possibly selected, by customer 305. According to one embodiment, kiosk 225 is configured to produce a paper version of the coupons selected by customer 305. The paper version may be in the form of individual coupons for each offer or all the offers may be combined on a single paper coupon. For example, the single paper coupon which contains multiple offers, may have multiple bar codes which may be scanned at the point of sale (PoS) 310 in order to activate the rewards. As another example, all of the multiple coupons may be printed as a list and then may be combined into a single bar code which, when scanned at PoS 310, activates all of the rewards printed in the list.

In another embodiment, kiosk 225 is communicably coupled to PoS 310. In this embodiment, the coupons or rewards selected by the customer at kiosk 225 are electronically associated and stored with the customer's unique identifier. Then, at PoS 310 customer 305 enters their unique identifier and the rewards, coupons, promotional offers, and/or the like which were selected are automatically applied to the purchases being made at PoS 310.

In some embodiment, PoS 310 is communicable coupled to the profiling module 315. According to an embodiment, profiling module 315 is capable of monitoring all of the purchase made through PoS 310. According to various embodiments, when customer 305 purchases one or more products, the customer first enters a unique customer identifier. The identification mechanism allows PoS 310 to associate the purchases made by customer 305 during each visit. According to one or more embodiments, PoS 310 may monitor and transfer the customer purchasing information in a variety of ways. For example, in one embodiment, PoS 310 may keep track of the data from each of the customers who enter a unique identification number for a predetermined period of time before it is transferred to profiling module 315. For example, the predetermined time period may occur on a periodic time period such as hourly, daily, weekly. In other instances, the transfer may occur based on an external trigger, such as a request from a system administrator, on-demand, or on a predetermined schedule. Yet still, in some embodiments, the transfer may occur after the transaction with the customer is complete. While in other embodiments, the data may be stored at the PoS until a request is received from profiling module 315.

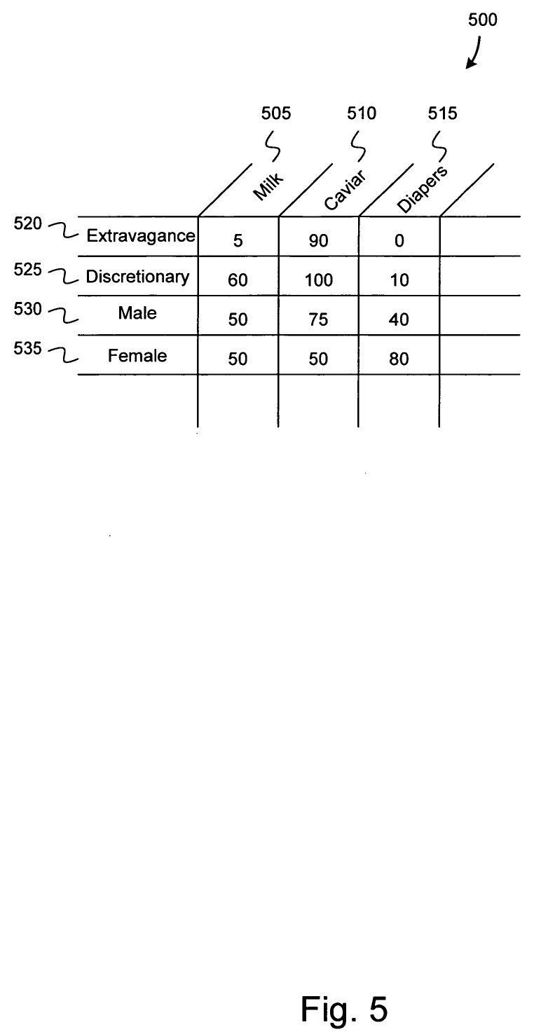

At a high level, the purchasing information collected by PoS 310 is used to form product matrix database 320. In some cases product matrix database 320 is populated by a system administrator, data entry person, and/or the like. In other instances product matrix database 320 may be automatically updated based information supplied by an external marketing agency, the product supplier, and/or the like. An exemplary type of information which may be stored in product matrix database 320 according to various embodiments of the present invention is described in more detail with FIG. 5.

According to various embodiments, when customer 305 purchases a product at PoS 310, a product identification is transmitted to profiling module 315. Profiling module 315 uses the product identification received from PoS 310 to access product matrix database 320 and product weighting matrix 325 to form a customer profile which may be stored in profile data database 330. Product weighting matrix 325 includes information related to a numeric weighting of characteristics according to products. In some embodiments, product weighting matrix 325 provides a weighting for the classification of the product in formulating the customer profile. For example, suppose extensive marketing studies and/or other experience have produced a high confidence level in the product matrix of one product that a customer is purchasing while another product matrix for a second product has a low confidence level. According to one embodiment, product weighting matrix 325 allows for the varying level of confidence in the product to be taken into account. In other embodiments, product weighting matrix 325 is a functional relation which takes into account the number of the product being purchased by the company, the cost of the product, if the product was on sale, what coupons were used, inventory levels of other related products, display location of the product, and/or the like in order to form an appropriate weighting of one product compared to another. One advantage of this function relation to produce the appropriate weighting is that it may help produce a more accurate development of the customer's profile. For example, if a product is placed near the entrance of the store, or near a checkout stand, this may significantly impact the impulsive categorization of that product. As another example, suppose an item which may normally have a high extravagance level, may be on sale making it not such an extravagant purchase. As such, a product weighting matrix 325 may be produced which corrects the classification of the purchase.

Then, when a retail client decides to have a promotion, a user interface to a promotion receiving center 335 may be used to enter the product and promotion information into promotional database 340. In one or more embodiments, promotion receiving center 335 may be accessed through a webpage found on the internet. In this case the retail client would enter a username and password in order to access the system. In other embodiments, the user may access the system over a secured LAN or WAN connection. Still yet, in other instances, the retail client may contact an account representative which has access to promotion receiving center 335.

Once the promotion receiving center is accessed, various information may be entered and/or account history of past, current, and future promotions may be reviewed and edited. For example, according to various embodiment, the retail client may enter a variety of information and/or preferences related to the production promotion. Typical information may include, but need not be limited to, a start/stop dates, a number of products or items available for the promotion, specific customer targeting information, and/or the like. Using some or all of the information entered, targeting module 345 then determines which customers should be targeted by each specific promotion. In some embodiments, this determination is based, at least in part, on the information in promotional database 340 along with the information in profile data database 330 and customer database 350.

If a customer is selected for the individual promotion, the information may be recorded in the customer profile held within customer database 350. Hence, when customer 305 interfaces with kiosk 225 by entering their unique identifier, the kiosk accesses with issuing module 355, which in turn looks up the customers profile, and transfers the promotional deals selected for that individual back to kiosk 225.

Creation of Exemplary Personalized Promotions

Some embodiments of the personal pricing system enhance aspects of traditional customer loyalty schemes. For example, personal pricing can enable customers to be treated as individuals. Individual customer treatment means that each customer may have a unique set of promotions and rewards tailored to his/her needs, interests, buying history, profile, actions, and the like. Using an embodiment of the personal pricing system, like the one described in FIG. 3, for example, a retailer is able to grant personal pricing promotions or rewards to a customer in response to predetermined events and/or data, such as, but not limited to, the following:
The customer identifies themselves to the personal pricing system—typically through the use of the Kiosk Terminals 225 within the store or accessed through a home computer.
After a customer identifies themselves at the Kiosk Terminal 225, a barcode scanner is used to view the information on a specific item.
After a customer identifies themselves at the Kiosk Terminal 225, various games related to specific advertisements can be played to win additional promotions and/or rewards.

According to a particular embodiment, promotions and rewards that are granted may then be used by the customer during the checkout process at the Point of Sale (PoS) system 310. Many PoS systems vary in the functionality they provide and their ability to calculate certain promotions. Therefore, embodiments of personal pricing systems and schemes have been designed to provide a plurality of promotional and reward opportunities. Some exemplary promotions are listed in Table 1.1. However, other promotions may which are well know to those skilled in the art may be used in accordance with various embodiments of the present invention.

TABLE 1.1
Exemplary Personal Pricing Promotion Types

| Promotion Type | Example |
|---|---|
| Markdown Item | Sale Price $10.99 (regular price $12.99) |
| Markdown Item by | 25% Off Item |
| percent | |
| Table Pricing | Save $0.40 off next 2 for after purchasing |
| | 3 units of an Item |
| Table Pricing - | Buy 5 get 2 Free |
| Buy ‘x’ Get ‘y’ Free | |
| Quantity Reward | Save $5.00 after purchasing 10 units of an Item |
| Sale Threshold | Spend $50.00 and get this Item for $1.00 Off - |
| | spend $100.00 and get this item for $3.00 Off |
| Coupon Reward | Prints up to two Coupons (for future use) when |
| | the Item is purchased |
| Weight Threshold | Buy a “weighted item” bigger than 2 lbs. and |
| | get $0.50 off per lb. - buy a “weighted item” |
| | bigger than 5 lbs. units and get $1.00 |
| | off per lb. |
| End Of Sale Table Price | Buy 3 and get the next 1 (lowest priced Item) |
| | for a 50% Off |

In one embodiment, the retailer selects the type of promotions offered through personal pricing based on the ability of the retailer's PoS system 315. Additionally, depending on the capabilities of the PoS system 315, the personal pricing system may be able to electronically transmit the promotions generated via personal pricing to the PoS system 315. Therefore, in this embodiment, as soon as promotions or rewards are given to the customer through personal pricing, the customer would have immediate access to these promotions at the PoS terminals without having to use any type of paper system such as coupons. As previously described, if there is no such electronic interface, the personal pricing system may have the ability to provide a printed list of the promotions and rewards available to the customer.

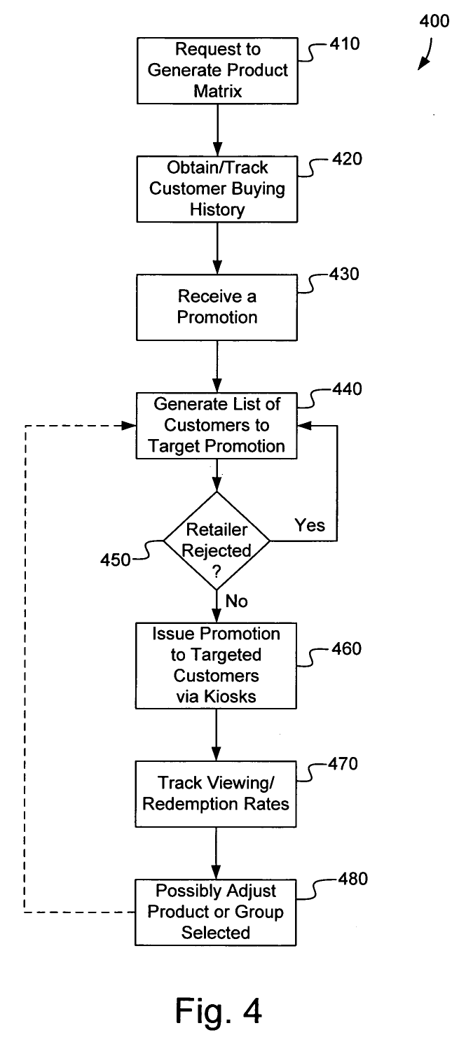

FIG. 4 is a flow chart representing an embodiment of an algorithm having operations capable of determining the personalized promotional offers and rewards which will be available to an individual customer in accordance with one embodiment of the present invention. In the embodiment described in flow diagram 400, after a retailer selects the product to be promoted, a requesting operation 410 to generate a product matrix is made. The request may originate from a retailer, a promo receiving center, and the like. Once the request is received, a product matrix may be generated based on the request. According to various embodiments which will be described in more detail below, a product matrix defines a mapping between customer purchases of the product and customer classification categories.

Once the product matrices are generated, obtaining customer buying history 420 by tracking, retrieving, monitoring purchases and/or the like may be performed. For example, in some embodiments, information about customer purchase such as product identifiers, quantity of the product purchased, frequency between purchases of the product, amount of money spent on the product, and the like may be monitored through PoS 310. This product information is associated with the unique customer identification number that the customer used when purchasing the products. Then, after receiving a promotion 430, the buying history may be utilized to form a customer profile which can utilized to screen customers which would most benefit from the promotion. In various embodiments, a functional relation may be applied to at least part of the information about the customer buying history and possible of information to form a customer profile. One example of a functional relation that may be used is a weighted average schema applied to one or more of the customer profiling categories.

After a customer profile is generated, a list of customers for the promotion may then be generated 440. In some embodiments, the customers may be sorted or prioritized for inclusion in the list of customers based on a selection criteria. For example, the retail customer, system administrator, and/or the like may set criteria comprising one or more ranges for which one or more of the customer profile categories within the customer profile must meet in order for the customer to be selected for inclusion on the list. In other embodiments a functional relation may be defined by a system administrator, a retail customer and/or the like which will combine the entries in one or more of the customer profile categories to create an overall score.

According to one embodiment, the retailer has a chance to review the customer list. Thus the retailer may be accepting or rejecting part or all of the list 450. For example, if the retailer decides that too many customers have been selected he may reject the list and input new selection criteria. Then, a new list may be generated based on new information, restrictions, or requirements that have been provided by the retailer. If the retailer accepts the list, the issuing of the promotions 460 to the targeted customers may occur via the kiosks 225. For example, when customer 305 enters their unique identification number, the kiosk accesses issuing module 355 to determine which promotions should be offered to the customer associated with this unique identification number.

Customer 305 is able to view and select which promotional offers he would like to accept and eventually redeem through the PoS system. Tracking the viewing rates and redemption rates 470 may be performed in accordance with some embodiments of the present invention. This viewing and redemption rate information may then be used in determining if a possible adjustment of the product or group selected 480 would be beneficial. For example, if a low percentage of the viewers of the personalized promotional offer are found to actually purchase the product, then the customer selection criteria may be modified. Based on this modification, generation a new list of customers 440 to which the target promotion is being offer may be performed.

In some embodiments, the process of creating a personalized promotional offer is created by using the Personal Pricing System Maintenance portal, or a user interface, to the promotional receiving center 335. To access this user interface, users of the personal pricing system may use a web browser to navigate to the personal pricing management server web site. A unique web portal site can be assigned to each individual “retail chain”. Each retail company can have its own configuration of the personal pricing system, tailored specifically to its individual needs.

FIG. 5 illustrates a simple exemplary product weighting matrix 325 which may be used in accordance with one embodiment of the present invention. According to one embodiment, a product weighting matrix is formed by assigning a weighting based on a product profile with each of a plurality of pre-selected customer classification categories. In the illustrative embodiment depicted, the products sold by the retail establishment, i.e., milk 505, caviar 510, diapers 515, and the like, are associated with rankings in various customer classification categories. For example, as depicted in FIG. 5, the customer classification categories may include, but need not be limited to, product classifications relating extravagance of the purchase 520, discretionary nature of the purchase 525, whether the product is purchased by male 530 or female 535. Again, these are exemplary illustrations, and as such are not meant to be in any way exhaustive lists, of both the types of products and classification categories that may be utilized in various embodiments of the present inventions.

According to one embodiment, the associated rankings or scores which are entered into the product matrix are percentages while in other embodiments they may be not percentages. In FIG. 5, the product caviar 510 has an extravagance rating of 90, a discretionary rating of 0, a male purchase rating of 75 and a female purchase rating of 50. While for illustrative purposes numerical scores have been used in the product matrix present in FIG. 5, any numerical, alphabetic, or other symbolic system capable to create rankings and relative associations which are known to those skilled in the art may be used with various embodiments of the present invention.

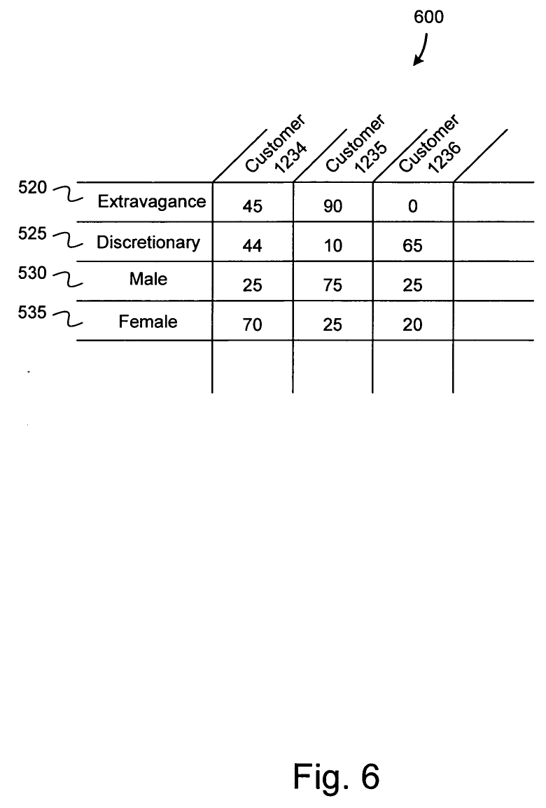

FIG. 6 represents a simple exemplary customer profile which may be used in accordance with various embodiments of the present invention. In accordance with one embodiment, a plurality of customers are anonymously identified using their unique customer identification numbers. According to one embodiment, no personal information such as names, addresses, marital status, and the like, is collected about the individual customers. As such, as previously described, the only information that may be collected about the customer involves information relating to the purchases of the individual customers. Thus, a customer profile is able to be generated anonymously, i.e., by only using information about the buying history of the customer and without using or knowing any personal information about the customer. For example, using a product profile matrix, along with the quantity, brand of product, and other collected information, a customer profile may be formed. In one embodiment, the customer profile is a matrix representing classification categories for the plurality of customers.

According to one embodiment, the associated rankings or scores which are entered into the customer profile are percentages while in other embodiments they may be not percentages. In FIG. 6, the customer 1235 has an extravagance rating of 90, a discretionary rating of 10, a male purchase rating of 75 and a female purchase rating of 25. According to one embodiment, the purpose of the customer profile is not to determine physical or psychological characteristics of the customer, such as whether the customer is male or female. Instead, the purpose is to identify a purchasing profile which is based on product classifications. This purchasing profile, or customer profile, may then be used to customized the rewards, coupons, and the like which are offered to the customer through the personalized pricing system. While for illustrative purposes numerical scores have been used in the customer profile matrix present in FIG. 6, any numerical, alphabetic, or other symbolic system capable to create rankings and relative associations which are known to those skilled in the art may be used with various embodiments of the present invention.

As previously mentioned, the product weighting matrix is combined with information recorded about the customer's purchases in order to created a customer profile. According to one embodiment, a functional relation which takes information such as the items purchased, quantity of the items purchased, item profile, the product matrices, and the like in order to determine the customer profile. For example, in an embodiment, the customer profile is created by forming a weighted average of each category entry by using the number of the item purchased and the weighting in the associated category. As another example, the weight of the item may be adjusted in the customer profile based on the relativity of previous purchases of an item.

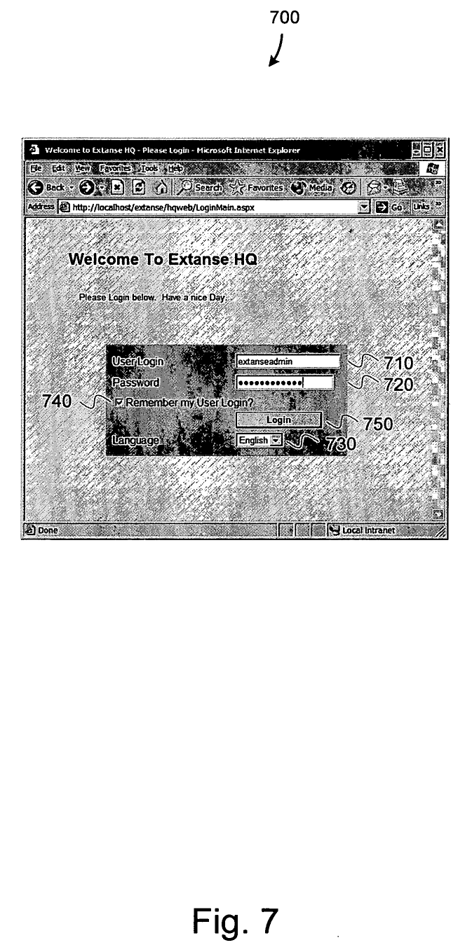

FIG. 7 illustrates an exemplary login screen 700 to a user interface of a promotional receiving center which may be used in accordance with one embodiment of the present invention. According to a particular embodiment, the retail customer uses login screen 700 to access HQ 205 by using an assigned “User Login” 710 and “Password” 720. According to one embodiment, the user is able to select from a list of languages 730 which will be used once the user signs on. In addition, according to some embodiments, the user is able to select box 740 to indicate whether User Login 710 and Password 720 will be remembered the next time the user returns to screen 700. In other embodiments, when the user selects box 740, only User Login 710 will be remembered and Password 720 will need to be entered by the user each time. One reason for requiring the user to enter Password 720 each time is to increase the level of security of the system. In any event, once the user enters User Login 710 and Password 720, the user selects login button 750. Once the user is authenticated as a valid system user, he/she is allowed to enter the a configuration site for the specific retail chain of interest. The initial screen will allow a system administrator access to all configuration parameters related to the specific retailer's system configuration.

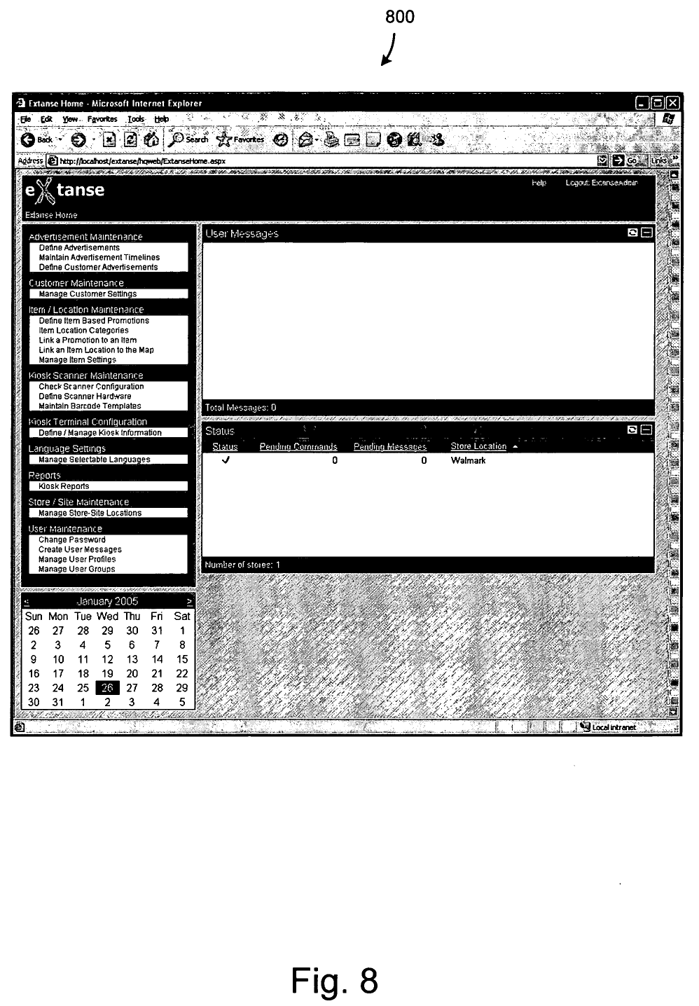

FIG. 8 illustrates an exemplary personal pricing system maintenance portal main page 800 which may be used in accordance with one embodiment of the present invention. Using the exemplary interface shown in FIG. 8, the personal pricing system administrator can begin to configure the personal pricing functionality for the retailer. According to the embodiment depicted, the administrator can perform a variety of tasks. For example, the administrator may perform advertisement maintenance, perform customer maintenance, perform item/location maintenance, perform kiosk scanner maintenance, configure the kiosk terminals, set language defaults and preferences, generate reports, perform store/site maintenance, and perform user maintenance.

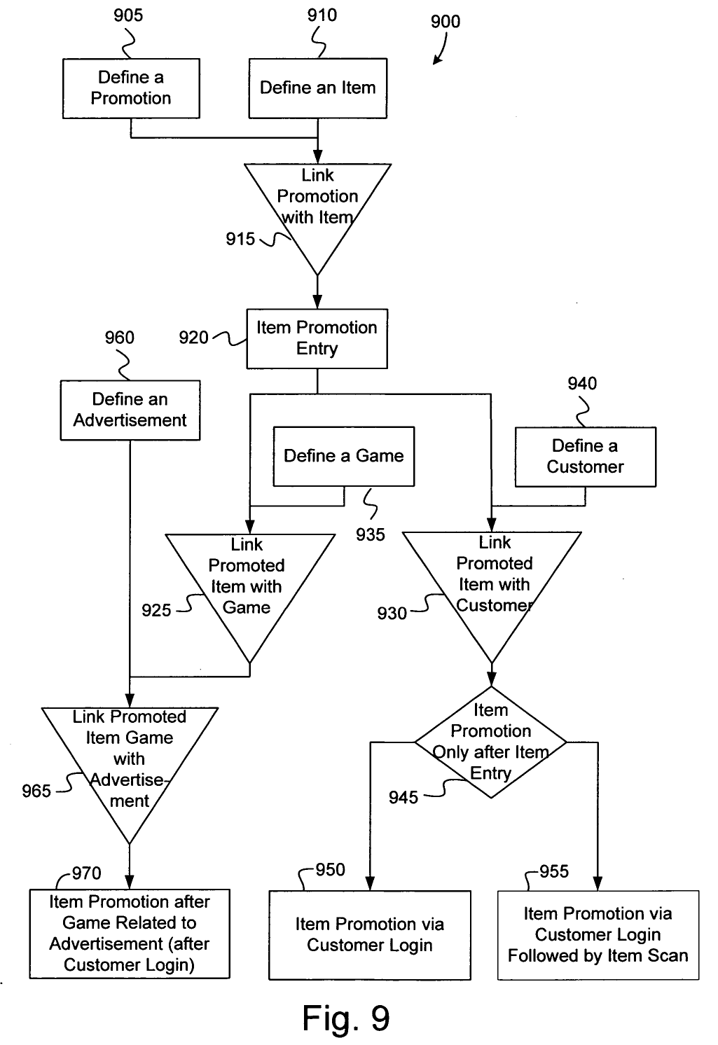

FIG. 9 is a flow chart representing an embodiment of an algorithm having operations in a process for creating personal pricing promotions in accordance with one embodiment of the present invention. In accordance with various embodiments of the present invention, one of the initial steps in creating a personal pricing promotion is a defining operation 905. In defining operation 905 a promotion is defined. In one embodiment, the personal pricing system allows the administrator the ability to define one or more basic promotions. For example, see Table 1.1 for some illustrative possible promotions. Another defining operation 910 involves defining an item, such as a product for promotion. In defining operation 910, the item for the promotion may be defined by receiving inputs from a system administrator, retailer, or the information may be retrieved from a database within the system. In accordance with some embodiments, a system administrator or retailer may define an item by navigating to a promotion maintenance screen from the maintenance portal main page 800. From there the administrator can select “Define Item Based Promotions” from the menu selection on the left side of the Personal Pricing System Maintenance portal screen in FIG. 8.

Linking operation 915 links the promotion with the item. Linking of an item with a promotion is typically done either manually, by a system entry, or automatically based on selection made by the retailer or system administrator. After linking operation 915, a creating operation 920 creates a promotion entry including the promotion and linked item in the Personalized Pricing System. From here, a linking operation 925 may be performed to associate the promotion with a game. Similarly, a linking operation 930 may also associate the promoted item with the customers on the list of selected customers. In accordance with various embodiments, these links may provide an electronic association indicating that a pre-defined game with rewards defined in the promotion may be displayed on a kiosk of a selected customer.

In another defining operation 935, a game may be defined. In defining operation 935, a system administrator can define game parameters, such as inputs, and images to be used during the game. If the promotion is going to be promoted with a specific subset of the retailer's customers, then another defining operation 940 defines the targeted customers. Defining the targeted customers may be carried out by the system administrator or retailer user. After the entering the item 945, the promoting of the item or product at customer login 950 may occur. For example, when a selected customer logs into the system using the unique identification number, a promotion of the product may be presented to the customer. In other embodiments, the customer is presented with one or more games which have the promotion as a reward for playing or winning the game. Still yet, in other embodiments, promoting the item or product with a promotion or advertisement occurs after the customer logs in and scans the selected item 955.

Defining an advertisement for the game 960 may be done by the system administrator or the retail client through one or more user interface screens available on the system. Various user interface screens which are in accordance with some embodiments of the present invention are described in more detail below. Once the advertisement is linked with the promoted item and game, the customer, after logging in, may see a promotion or advertisement after successfully playing the defined game, see block 970. The implementation, according to one embodiment, of these steps are described in more detail below.

Exemplary Promotions

Once selected, the Promotion Maintenance screen may be displayed. Existing promotions are listed on the left side of the screen. To configure a promotion, the user selects an existing promotion from the list or creates a new promotion by pressing the “New” button. Next, a promotion type can be selected. Based on the promotion type selected, the required promotion configuration settings in the right part of the screen will change.

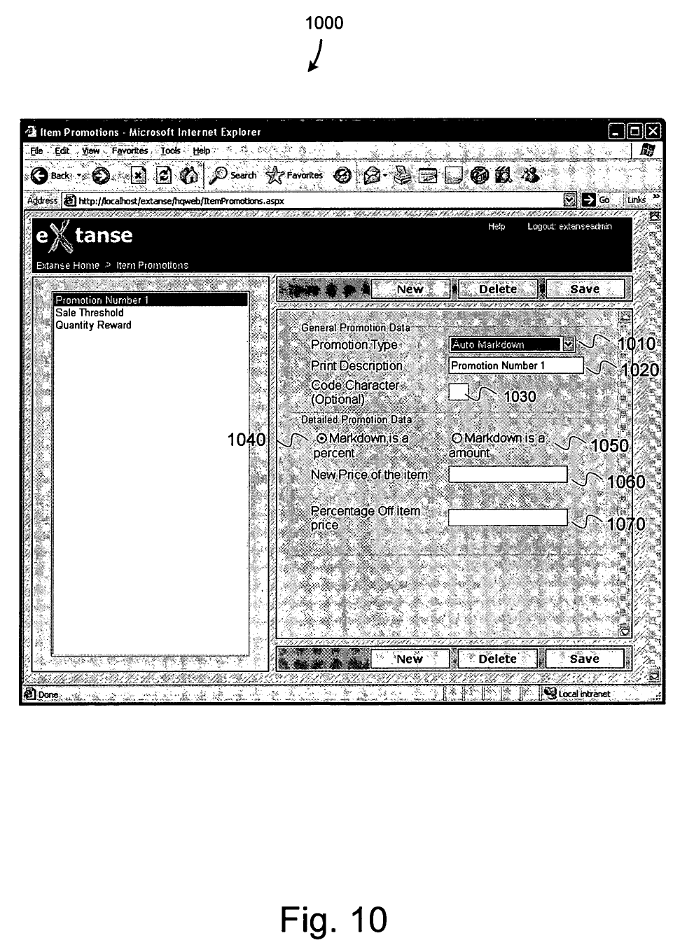

According to one embodiment, one promotion type is the Automatic Markdown promotion. The Automatic Markdown promotion permits a markdown on an item. FIG. 10 represents an exemplary user interface which may be used by an administrator to set up an Automatic Markdown promotion which may be used in accordance with one embodiment of the present invention. According to one embodiment, the administrator may select the type of promotion from drop down list 1010. If the automatic markdown promotion is selected, then, according to one embodiment, the administrator has the option to enter a customized name for the promotion in text box 1020. Check box 1030 allows the optional entry of a code character. In accordance with various embodiments, the code character is an optional alphanumeric character or symbol that may be included with the promotional information. This character may be used by the POS system to identify that a specific promotion applied to an item. According to some embodiments, the code character may be displayed on the POS user interface or on a printed receipt. For example, the code character may be displayed on the user interface or on a printed receipt next to the item placed on promotion. In addition, to the option code character, the administrator may either select a percentage markdown 1040 or an amount markdown 1050. Then, the new price of the item, or enter the percentage off the item, may be entered in either text box 1070 or 1060, respectively.

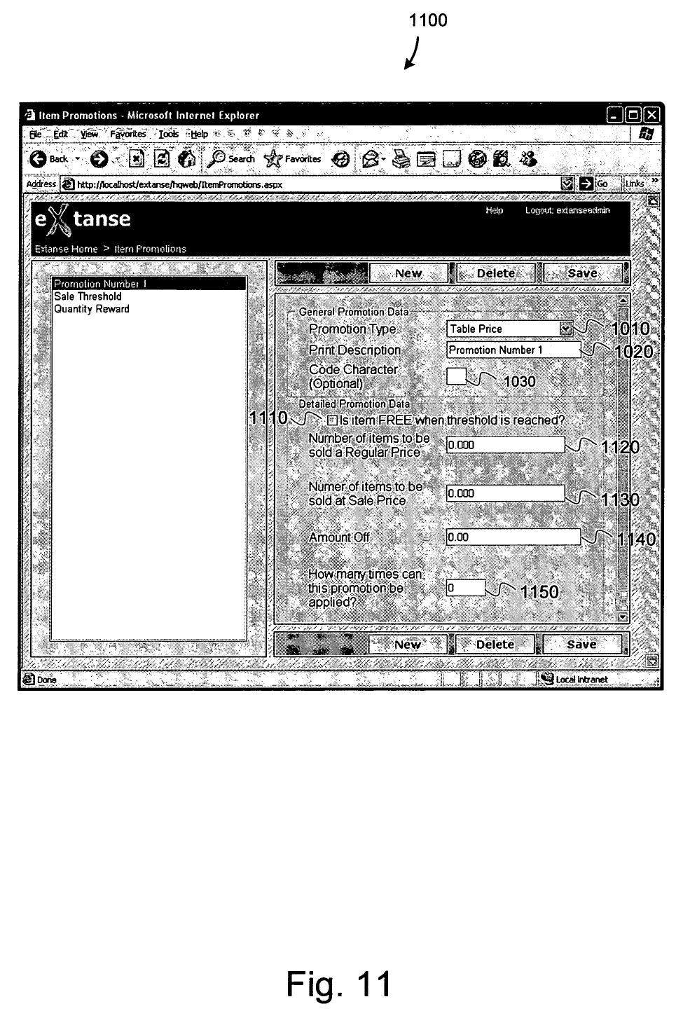

Again, according to one embodiment, the administrator may select the type of promotion from drop down list 1010. Another possible selection from this list is the Table Pricing promotion. In one embodiment, using the Table Pricing promotion type, the administrator may configure a promotion such as, “Save $0.40 on the 4^{th} Item for every 3 Items purchased”. This promotion type can also be used to define a “Buy ‘x’ Get ‘y’ Free” type of promotion as seen in FIG. 11. Check box 1110 allows the administrator to select if the item will be free when the threshold is set. If the box is not checked then the administrator may indicate the discount, or new price, which the item will be sold at once the threshold is reached. In the embodiment depicted, text box 1120 allows the administrator to enter the number of the product which much be purchased in order for the promotion to be triggered. Text box 1130 allows the administrator to enter the number of products which will be offered at the reduced, or free, price once the threshold indicated in textbox 1120 has been met. If the item is not free, then the amount off the product may be set by the administrator in text box 1140. Finally, the administrator may select the number of times the promotion may be used by an individual customer by entering a number in box 1150.

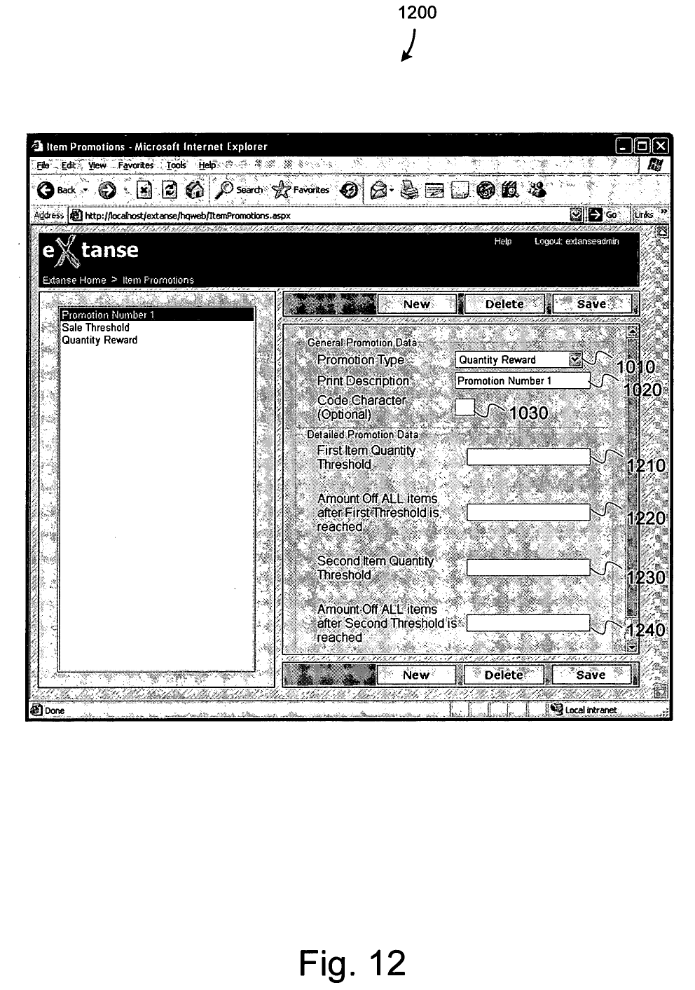

In another embodiment, a user interface for setting up a Quantity Reward promotion type, which may be selected from drop down box 1010, is shown in FIG. 12. In a Quantity Reward promotion, the administrator can define a promotion, such as “Save $5.00 on each Item after purchasing 10 units of an Item.” The administrator may enter the first item quantity limit which triggers the promotion in text box 1210. The amount to be saved on each additional item may then be entered in text box 1220. This promotion may even have a second threshold, which may be entered in text box 1230, defined to allow for even greater savings after meeting the next quantity of items. The amount of savings triggered by the second threshold may be entered in text box 1240. For example, this promotion may be defined: “Get $0.50 off after purchasing 20 of an item, but purchase 40 and the savings increase to $0.75 off an Item.” If a second threshold is not desired, the second set of values may be left blank. One goal of this type of promotion is to encourage volume purchases.

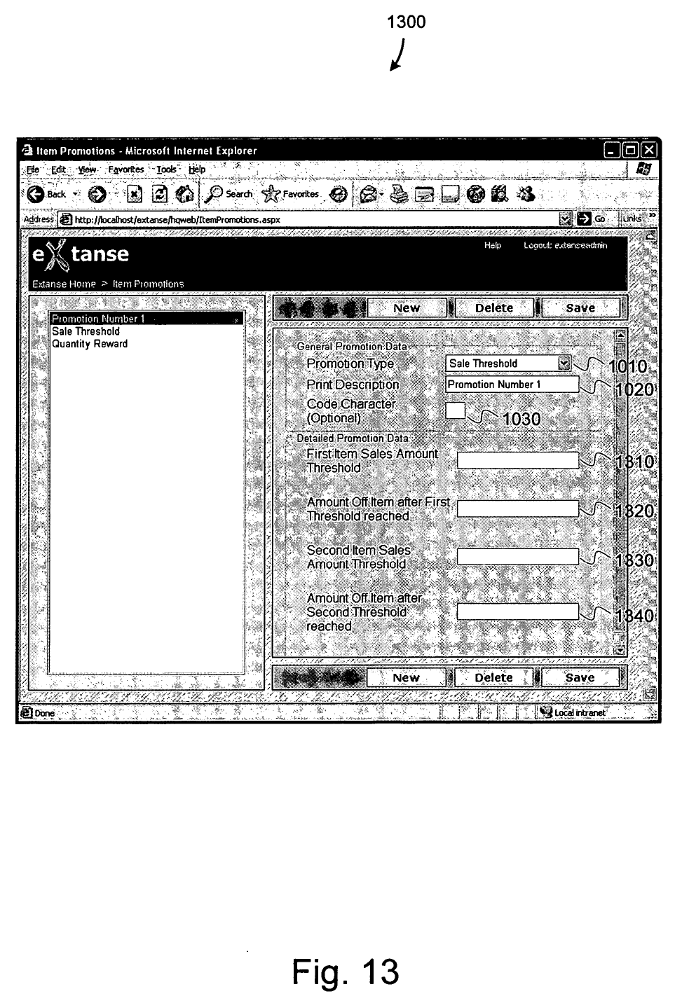

J FIG. 13 represents an exemplary user interface which may be used by an administrator to set up a Sale Threshold promotion in accordance with one embodiment of the present invention. A Sale Threshold promotion allows the administrator to define a promotion that will reward a customer for spending a specified monetary amount. The administrator may enter the first item sales amount limit which triggers the promotion in text box 1310. The amount to be saved on each additional item may then be entered in text box 1320. This promotion may even have a second threshold, which may be entered in text box 1330, defined to allow for even greater savings after meeting the next quantity of items. The amount of savings triggered by the second threshold may be entered in text box 1340. For example the administrator could define the following promotion: “Buy $20 worth of beef—get $5 off your Thanksgiving turkey.” This promotion also provides a second threshold and discount level. If the second threshold functionality is not necessary, these fields may be left blank.

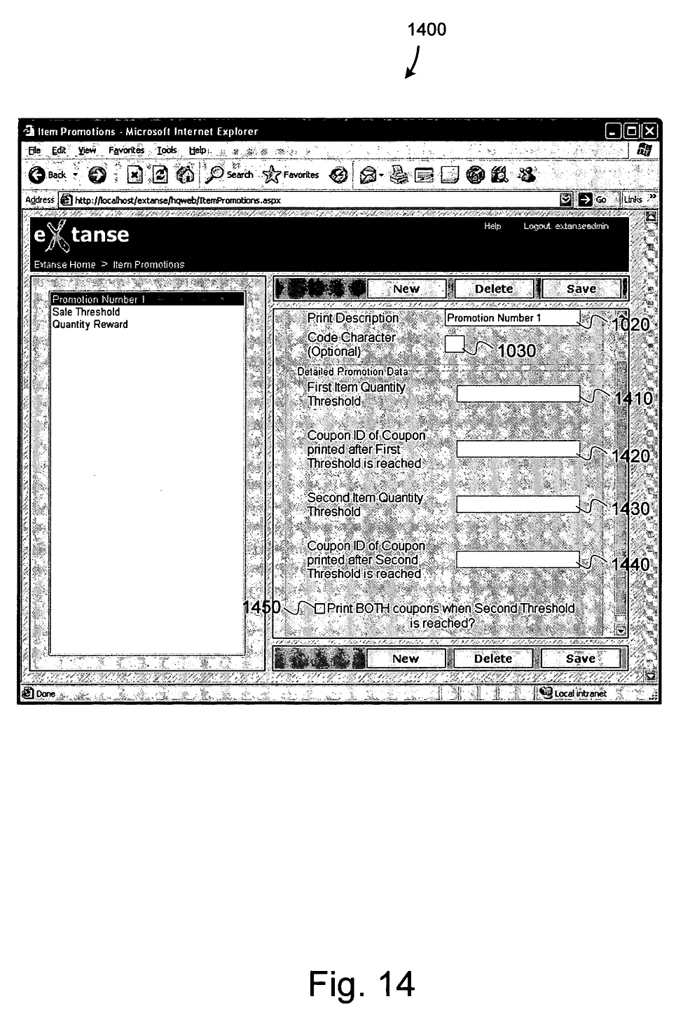

FIG. 14 represents an exemplary user interface which maybe used by an administrator to set up a Coupon Reward promotion in accordance with one embodiment of the present invention. The Coupon Reward promotion, which may be selected from drop down box 1010 (not shown in FIG. 14), provides a method to issue the customer with a reward for a discount on a future purchase. An example of this type of promotion would be, “Buy 2 gallons of milk—get a coupon for $2.00 your next visit.” This promotion also has the ability to print a second reward coupon based on a second threshold value.

According to one embodiment, the administrator may enter the first item quantity threshold which triggers the promotion in text box 1410. The amount to be printed on the coupon may then be entered in text box 1420. This promotion may even have a second item quantity threshold, which may be entered in text box 1430, defined to allow for even greater savings after meeting the next quantity of items. The amount of the coupon triggered by the second threshold may be entered in text box 1440. In addition, the administrator has the option of selecting check box 1450 which will print both the first and second coupon when the threshold is reached.

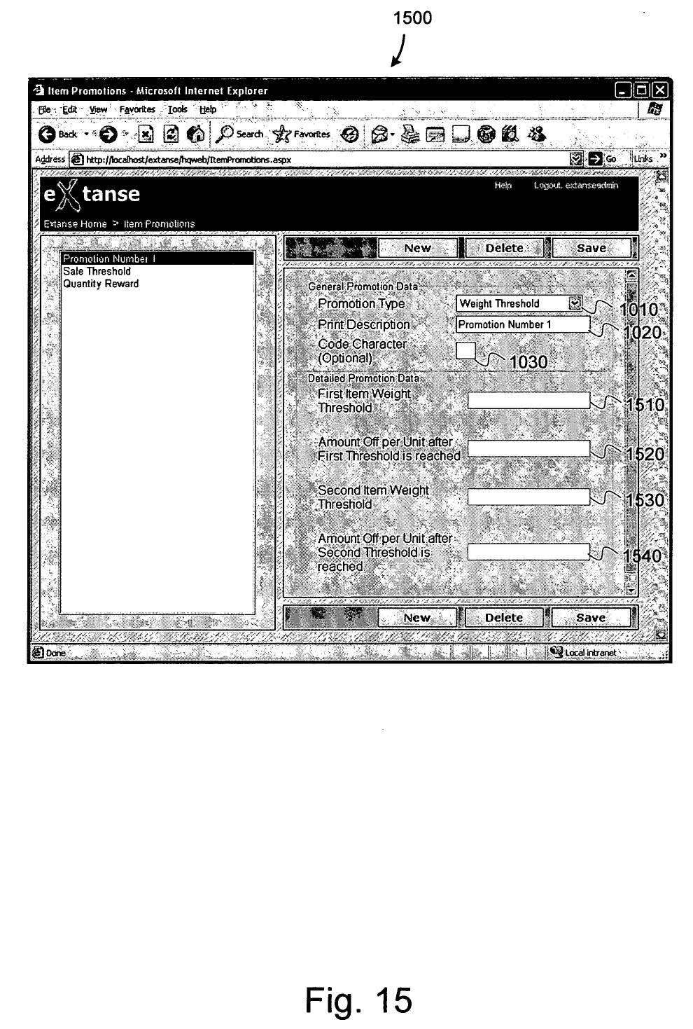

FIG. 15 represents an exemplary user interface which may be used by an administrator to set up a Weight Threshold promotion in accordance with one embodiment of the present invention. The Weight Threshold promotion, which may be selected from drop down box 1010, allows for a promotion based on the weight of weighted items sold. For example, the administrator may define the following promotion: “Buy 5 lbs. or more of apples—get $0.50 off per pound.” This promotion is very similar to the Quantity Reward promotion, but this promotion specifically deals with items that are sold by weight. This promotion also allows for a second item weight threshold and reward. If this second threshold is not necessary, these fields can be left blank.

According to one embodiment, the administrator may enter the first item weight threshold which triggers the promotion in text box 1510. The amount off per unit once the first threshold is triggered may then be entered in text box 1520. This promotion may even have a second item weight threshold, which may be entered in text box 1530, defined to allow for even greater savings after meeting the next weight threshold of items. The amount of the savings triggered by the second threshold may be entered in text box 1540.

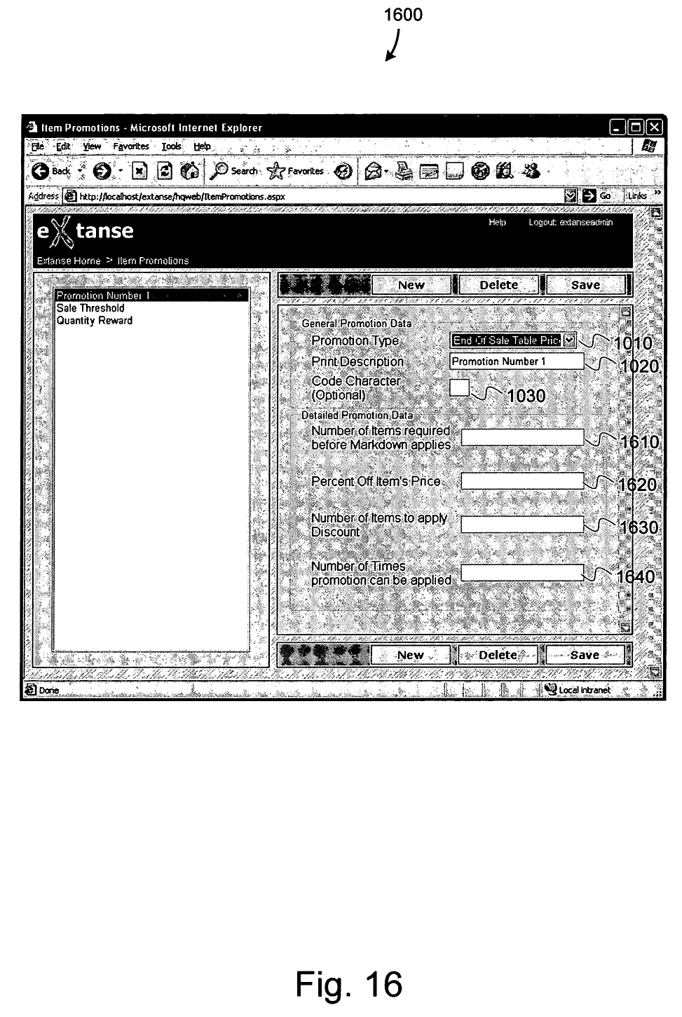

FIG. 16 represents an exemplary user interface which may be used by an administrator to set up an End Of Sale (EOS) Table Pricing promotion in accordance with one embodiment of the present invention. The End Of Sale (EOS) Table Pricing promotion, which may be selected from drop down box 1010, is very similar to the Table Pricing promotion. However, the Table Pricing promotion is only meant to be based on quantities of a single item. The EOS Table Pricing promotion allows for the promotion to be based on different items with differing prices. Therefore this promotion will handle the following type of promotion, “Buy 3, get the lowest priced item for 50% off.” The distinguishing feature of this promotion is that the calculation of the reward is done at the end of the sale. The regular form of Table Pricing applies the discount while the items are being entered into the sale. In accordance with one embodiment, this method does not allow for the calculation of the “lowest priced” item to be used in the reward. The optimal point at which to determine the “lowest priced” item would be after all the items have been entered in the sale—at End Of Sale.

According to one embodiment, the administrator may enter the number of items required before the markdown applies in text box 1610. The percent off the item's price once the first threshold is triggered may then be entered in text box 1620. Text box 1630 allows the administrator to setup the number of items the discount will apply to. While text box 1540 allows the administrator to indicated the number of times the promotion may be used by a customer.

Item Selection

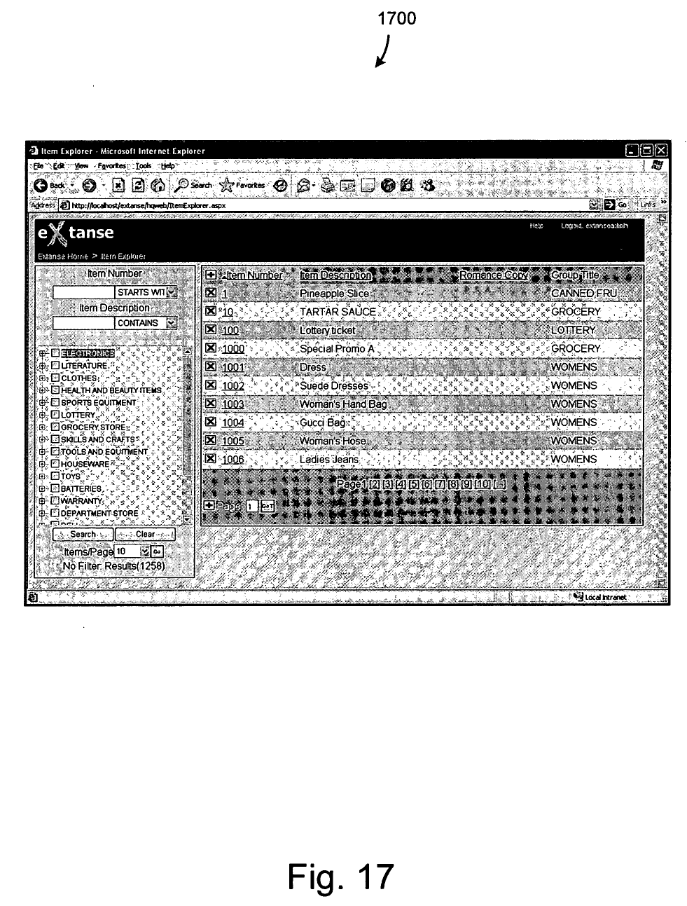

In some embodiments, before a promotion can be used by personal pricing, the promotion is associated with an item. To define an item within the personal pricing system a user would use the “Manage Item Settings” option from the personal pricing system main screen. FIG. 17 illustrates an exemplary Item Explorer interface which may be used to locate items or add new items to the personal pricing system in accordance with one embodiment of the present invention. Selecting this option will display the “Item Explorer” screen 1700. This screen can be used to find a specific item, to delete a specific item, or to create a new item in the system.

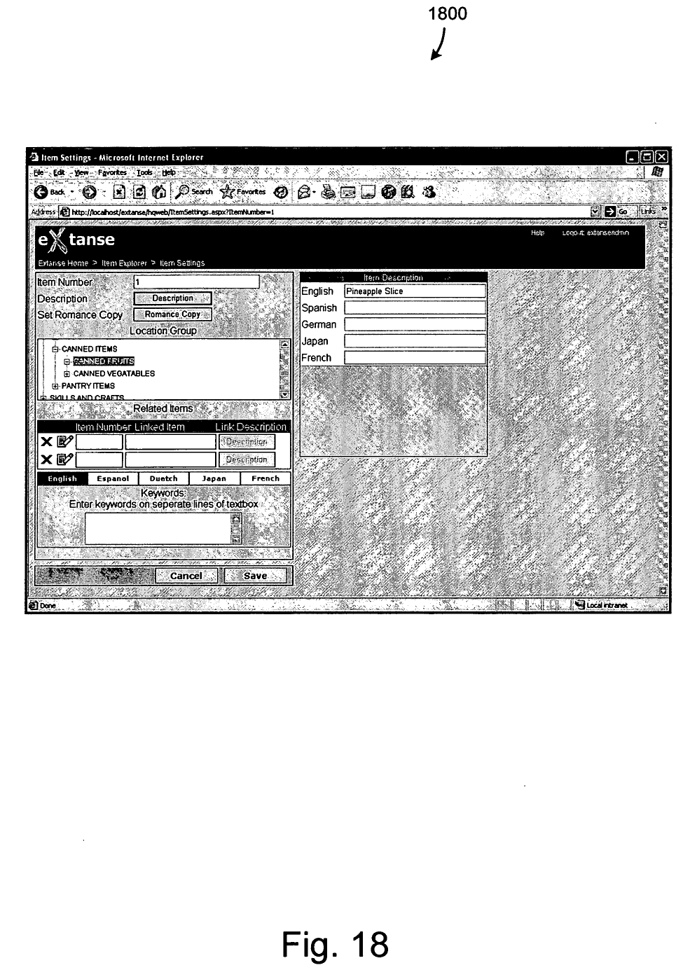

FIG. 18 represents an exemplary Item Settings page that may be displayed after an item is selected or created in accordance with one embodiment of the present invention. Using this interface, information about this item, such as description, location within the store, etc. may be defined.

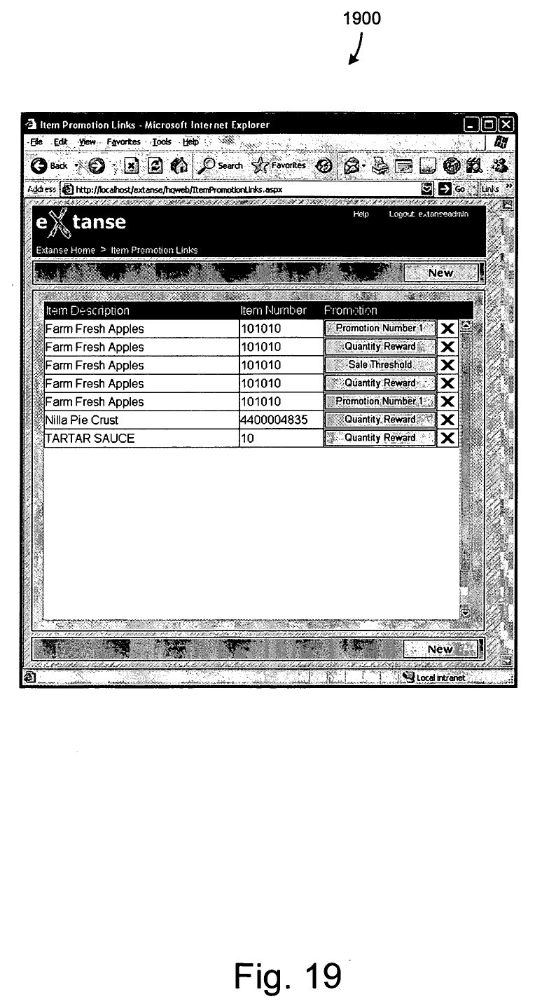

Once the item is defined, the promotion and item may be linked together. This process is accomplished using the “Link a Promotion to an Item” option on the Personal Pricing System main screen 800. Selecting this option will display the “Item Promotion Links” page. FIG. 19 illustrates an exemplary Item Promotion Link page which may be used in accordance with one embodiment of the present invention. In accordance with one embodiment, page 1900 will list all the promotions that will be available for use with the personal pricing system. Using this interface the administrator can select to add, delete, or modify the links between promotions and items.

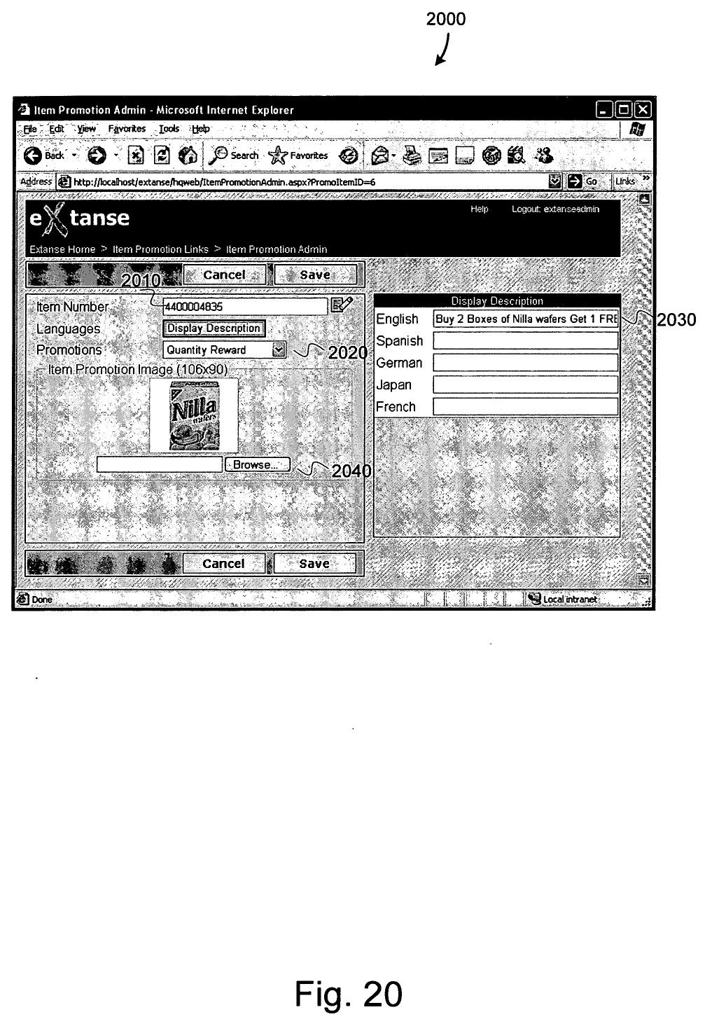

FIG. 20 illustrates an exemplary Item Promotion Admin screen which may be used in accordance with one embodiment of the present invention. According to various embodiments, the Item Promotion Admin screen 2000 will provide the interface which will allow the definition of the linked promotion and item. In addition to the item number, which may be entered into text box 2010, and promotion, which may be selected from drop down menu 2020, the display text describing the promotion should be defined in text box 2030, and an optional image may be linked to this item promotion entry using field 2040. This image will be displayed when the promotion is displayed to the customer when the customer views their promotions at a Personal Pricing System Kiosk Terminal.

Once an Item Promotion entry has been created, the entry may be used as a reward for personal pricing. The Item Promotion may now be used as a prize for a game or assigned to a specific customer.

Configuring Display Advertisements

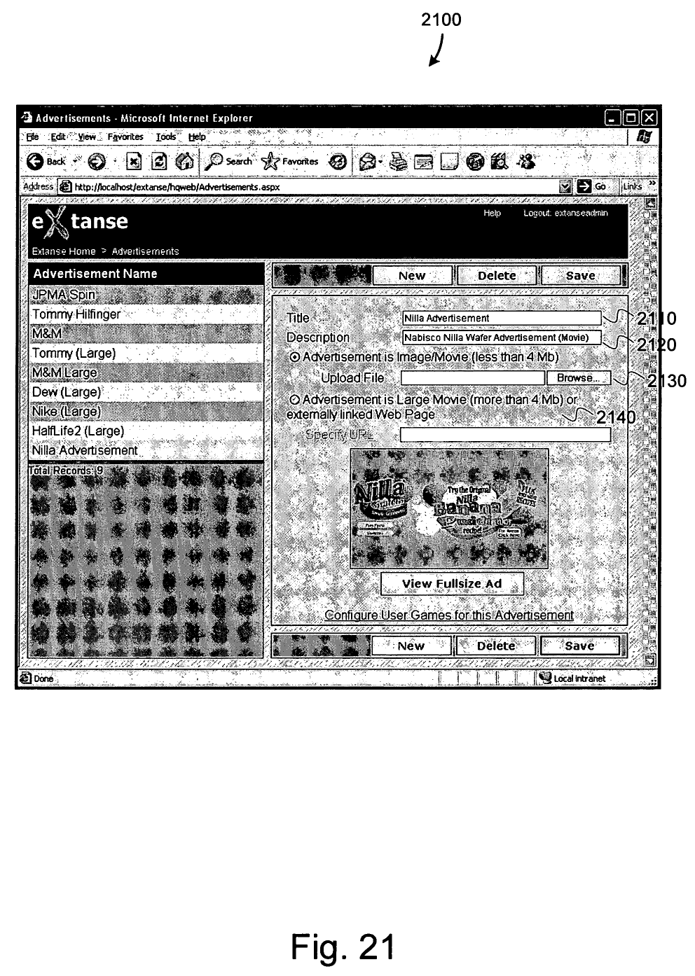

According to some embodiments, games can be defined and made available at the kiosk. The initial step in defining a game is to create or select an advertisement to be associated with the game. Using the Personal Pricing System Maintenance Portal main page 800 the administrator should select the “Define Advertisements” option. The “Advertisements” maintenance screen will then be displayed. FIG. 21 represents an exemplary advertisements maintenance screen which may be used in accordance with various embodiments of the present invention. Using screen 2100 the administrator can set the title 2110, description 2120, and display image of the advertisement by using either field 2130 or 2140 depending on the size of the image. Once the advertisement is defined, the administrator may link games to the advertisement by clicking on the “Configure User Games for this Advertisement” link. In one embodiment, defining a game for an advertisement is optional. Thus in some embodiments, the personal pricing system does not require every advertisement to have a game associated with it. In other embodiments, the personal pricing system may require a game to be associated with each advertisement entered.

Games

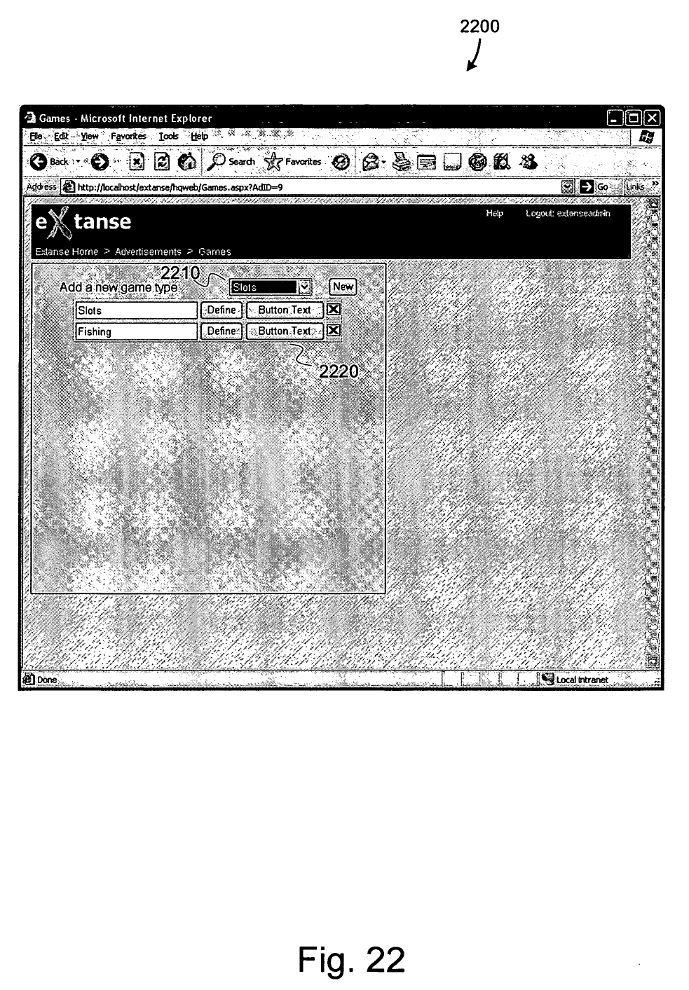

According to the embodiment depicted in FIG. 21, clicking on the “Configure User Games for this Advertisement” link will display a user interface screen from which one or more games may be selected. FIG. 22 illustrates an exemplary games page which may be used in accordance with various embodiments of the present invention. In one embodiment, an unlimited number of games may be associated with an advertisement. Using interface 2200 the administrator may select the types of games using drop down box 2210 to associate with the current advertisement. According to one embodiment, one or more games may be associated with a particular advertisement.

Once a game is linked to an advertisement, the “Button Text” 2220 can be set for the game. This text is displayed on the kiosk to the customer, describing the game to be played. To actually configure the game, the “Define” button should be pressed.

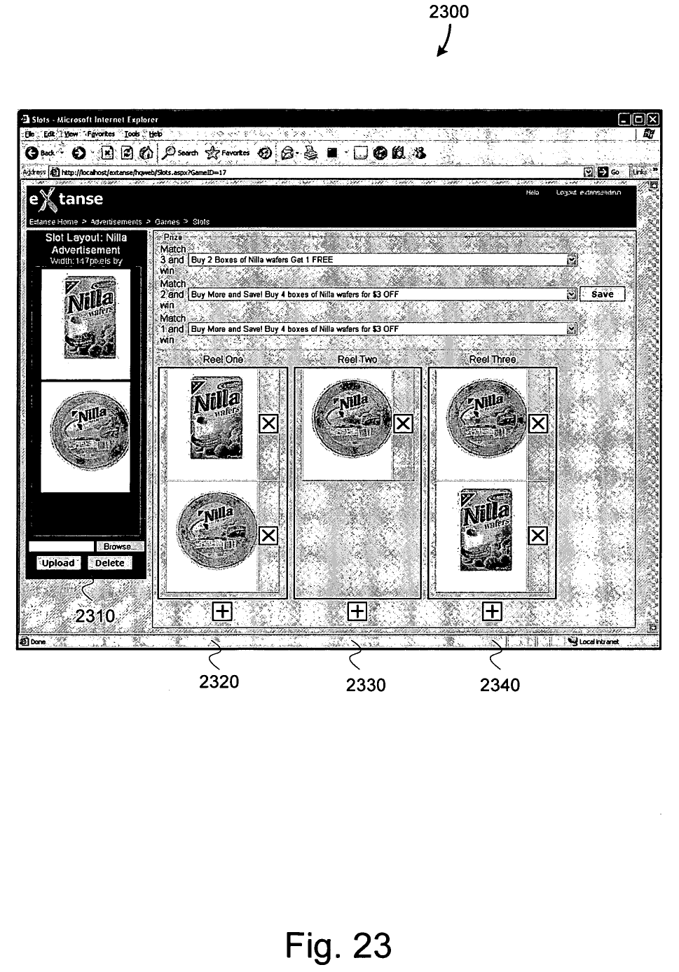

Each type of game will have a different configuration screen, since each game requires different configuration parameters. One exemplary embodiment of a game is a slot machine game. FIG. 23 illustrates an exemplary slot machine configuration page which may be used in accordance with various embodiments of the present invention.

For example, to configure the slot machine game, the administrator may load images into the “image list” 2310 located on the left side of the screen. After the images are loaded into the list, the administrator can then place the images into one of the three slot “reels” 2320, 2330, or 2340. An unlimited number of images may be entered into the image list, and an unlimited number of these images may be then placed into slot reels 2320, 2330, or 2340.

The odds of successfully matching “slots” depend on the number of different images used in the reels and the frequency they are duplicated within the wheel. For example, in the sample slot machine configuration screen 2300, since there is only one image in “Reel Two”, 2330, when this slot is played by the customer, this image will always appear in every slot “Reel Two” as the wheel spins. This configuration would significantly skew the odds of matching 3 “Nilla Pie Crusts”, while making it impossible to match 3 “Nilla Wafers” and significantly reducing the chance of matching just one reel (no match) or two reels.

Once the layout of the slot reels is complete, the administrator can select the promotions to associate with this game. In some embodiments, the games within the personal pricing system allow the administrator the ability to give a reward for every outcome. Even if the customer plays the game and is unsuccessful, the personal pricing system can be configured to still reward the customer just for playing the game. The list of promotions available for association is from the list of Item Promotions created in the “Item Promotion Link” screen 1900. Once saved, this game will be ready to reward customers with personalized promotional offers at a Personal Pricing System Kiosk.

In some embodiments, personal pricing uses advertisements displayed on the Personal Pricing System Kiosk Terminals to promote various products or brands to the customers. In accordance with one embodiment, during idle periods, i.e., while no customers are active, the kiosk terminals will be presenting advertisements on the screen.

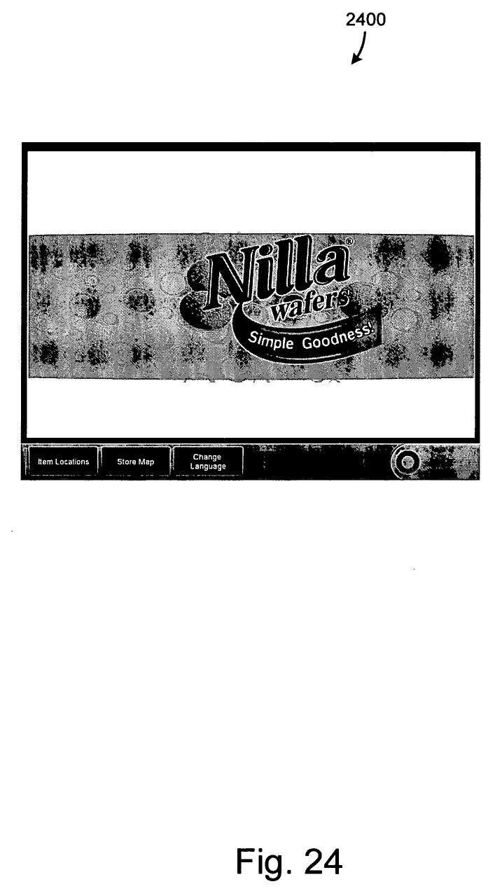

FIG. 24 illustrates an exemplary Personal Pricing System Kiosk display advertisement which may be displayed during idle periods in accordance with various embodiments of the present invention. If the customer is interested in getting an additional personalized promotional offer related to the advertisement, the customer may either scan their customer card or touch the screen.

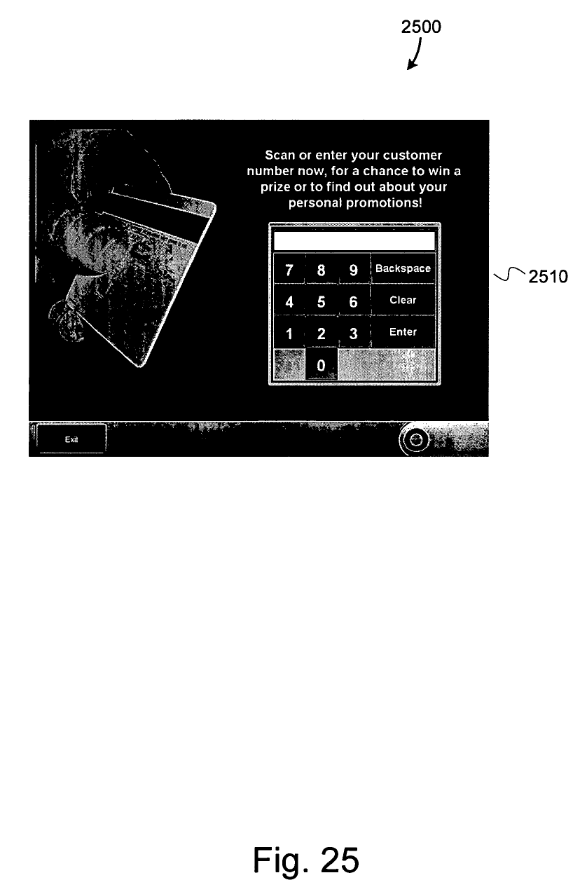

FIG. 25 illustrates an exemplary screen which may be displayed when a kiosk screen is touched requiring the customer to enter their customer number. The entry may be done by using a touch screen keyboard 2510, a barcode scanner (not shown), or a magnetic stripe reader (not shown). Once the customer has logged into the system, the customer may then select to play any games related to the advertisement.

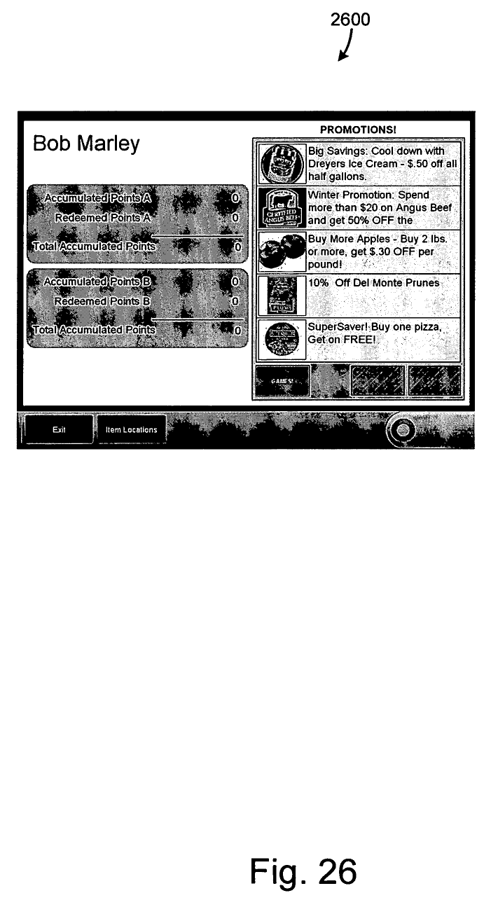

In a particular embodiment, once the customer identification number has been entered an validated, a customer screen will be displayed. FIG. 26 illustrates an exemplary customer screen which may be used in accordance with various embodiments of the present invention. This screen contains a variety of information related to the customer. The information on the left, such as last visit date, and “Points” are obtained from the point of sale system.

On the right side of the screen there is a list of the personal pricing promotions given to the customer just for logging into the personal pricing system. Embodiments for the configuration of this procedure is discussed in detail below.

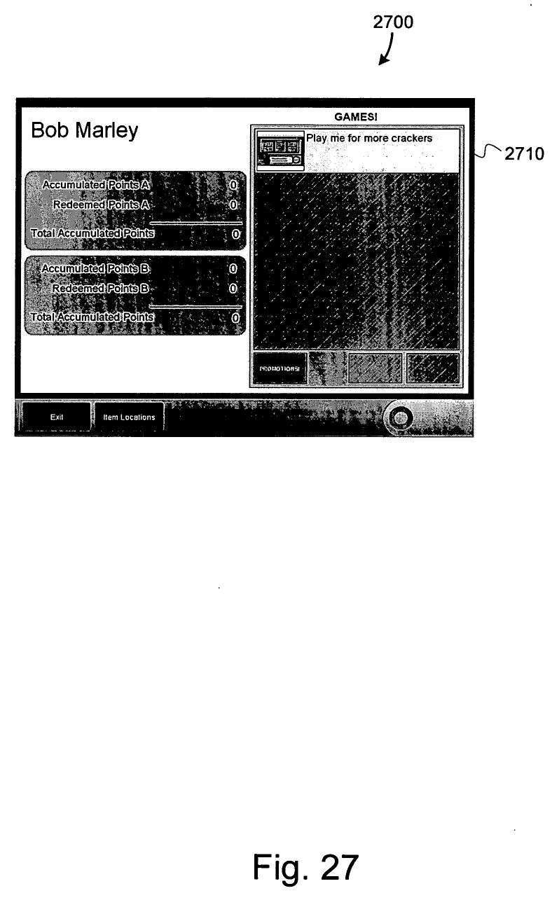

According to one embodiment, the customer is able to navigate to a screen in which the games that are available to the customer may be viewed. FIG. 27 represents an exemplary screen in which the customer is able to view the available games in accordance with various embodiments of the present invention. To view the games currently available to the customer, the administrator can press the “Games” button on the screen. The list on the left side will change to be a list of games available based on the advertisement that was being displayed when the customer signed into the system. These games are typically related to the advertisement and are used as an additional method to promote the product or brand being advertised.

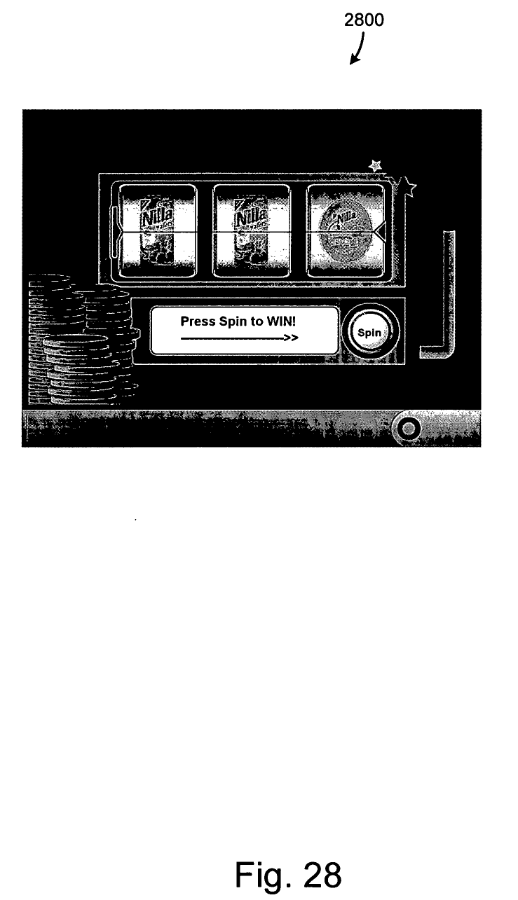

To play a game, the customer can click on game entry 2710 in the list. In the current example, this will display the slot machine game. FIG. 28 represents an exemplary slot machine game which is ready for play by the customer which may be used in accordance with various embodiments of the present invention.

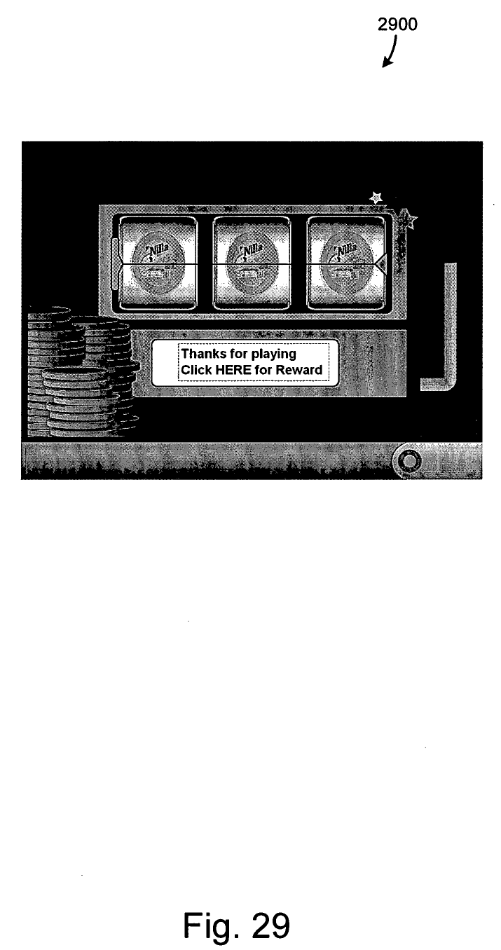

Once the game is loaded, the customer can play the game as instructed. FIG. 29 represents an exemplary screen shot of a slot machine game which has been played by the customer which may be used in accordance with various embodiments of the present invention.

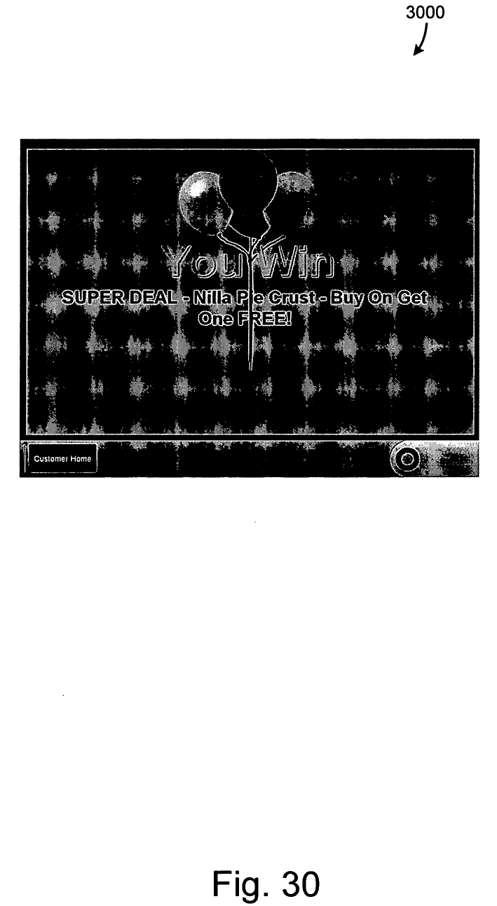

Once the game completes, as seen in screen 2900, the customer is transferred to the prize page. FIG. 30 represents an exemplary prize page which may be used in accordance with various embodiments of the present invention. The prize rewarded to the customer is immediately applied to that customer's personal pricing information. In addition to displaying the prize screen 3000, the reward promotion has been added to the customer's list of personal pricing promotions. According to one embodiment, the promotion rewarded as a prize would typically be related to the original advertisement that was interrupted by the customer.

The customer may then exit this prize screen and return back to the Customer Main screen 2700. The customer may then choose to play the same game again to attempt to win a better reward, or play any additional games that may be available.

Additional Reward Mechanisms

The personal pricing functionality also allows for the customer to receive their personal pricing promotions and rewards by just identifying themselves to the personal pricing system. As soon as the customer identifies themselves at the Personal Pricing System Kiosk Terminal, the default, personal promotions will be immediately linked to the customer.

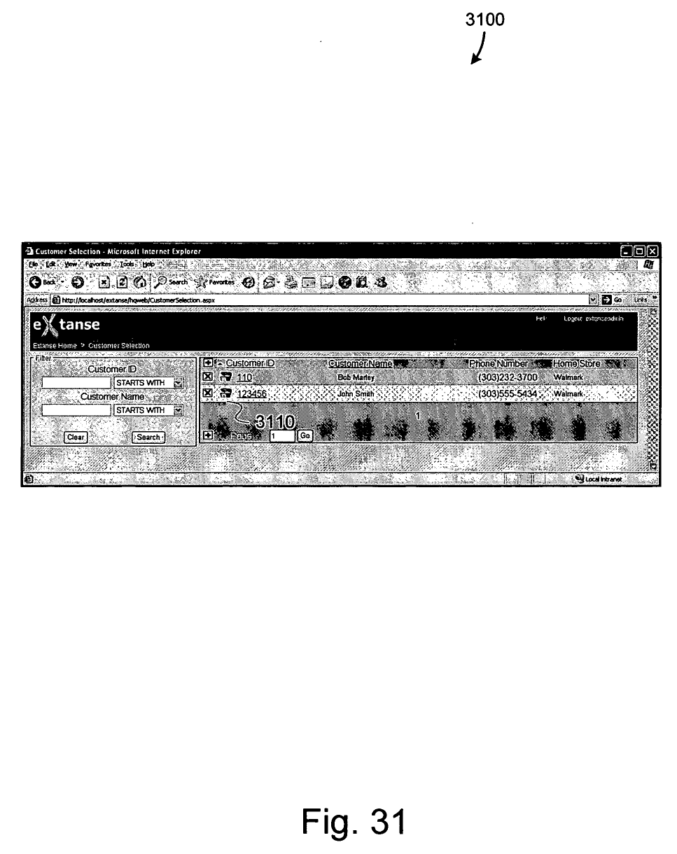

To configure these default promotions for the customer, the Personal Pricing System administrator would select the “Manage Customer Settings” from the Personal Pricing System Maintenance Portal main page. This option causes the Customer Selection screen to be displayed. FIG. 31 represents an exemplary Customer Selection screen which may be used in accordance with various embodiments of the present invention. Using this screen, the administrator may select an existing customer for update or add a new customer to the personal pricing system.

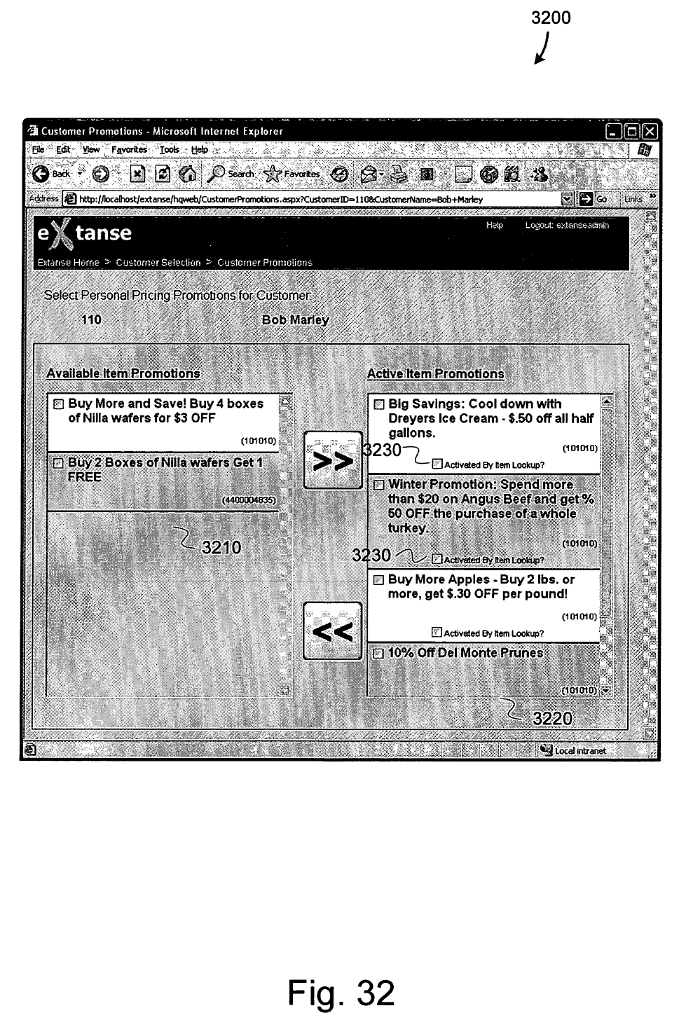

To maintain the personalized promotional offers and rewards for a customer, the administrator can click the treasure chest icon 3110 of the desired customer. This operation would display the “Customer Promotions” screen. FIG. 32 represents an exemplary Customer Promotions screen which may be used in accordance with various embodiments of the present invention. Displayed on this screen are two lists. List 3210 on the left side displays all the currently available promotions to assign to this customer. List 3220 on the right side displays the currently selected promotions that will apply to the customer.

Additionally, this interface allows the administrator the ability to specify which of the customer's promotions will only apply when the customer views the item information at the Personal Pricing System Kiosk Terminal. This setting is activated by checking the “Activated By Item Lookup?” checkboxes 3230 contained within each active promotion. If the box is checked, the promotion will only apply when the customer logs into the personal pricing system and follows by viewing the item information related to the promoted item.

According to an embodiment, once the customer is identified at the Personal Pricing System Kiosk terminal, the customer is presented a list of their default promotions in the Customer Main screen 2600. Using the interface the customer may scroll through the list of rewards which are available. The customer is not required to do anything further to obtain these promotions. In some embodiments, these rewards are made active just by the customer identifying themselves to the personal pricing system, using the Personal Pricing System Kiosk terminals.

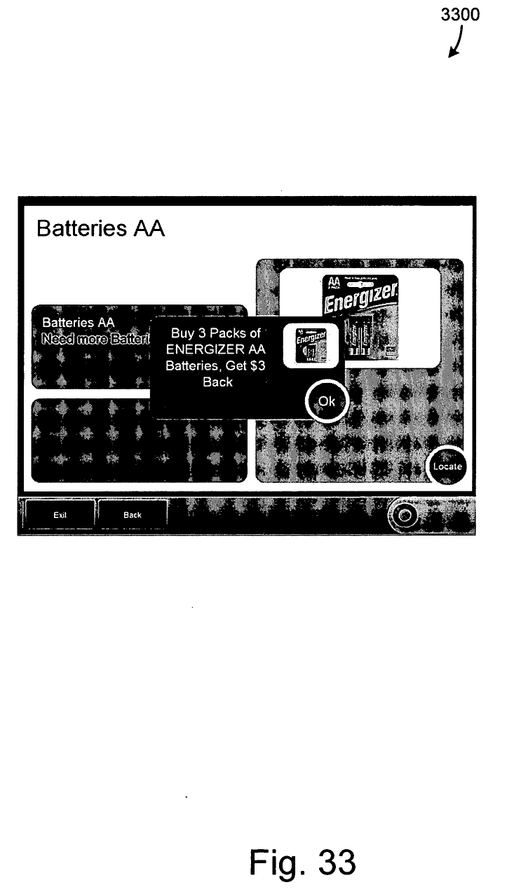

If a customer was now to scan or search for an item to learn more about the specific product, a promotion may be rewarded to that customer. This reward will be immediately added to the customer's list of personal pricing promotions. If there is a personal pricing reward for a specific item is in the customer's personal pricing information, a message will be displayed to the customer when the information for the item is displayed. FIG. 33 represents an exemplary screen shot of the notification of a personal pricing reward for a specific item which may be used in accordance with various embodiments of the present invention.

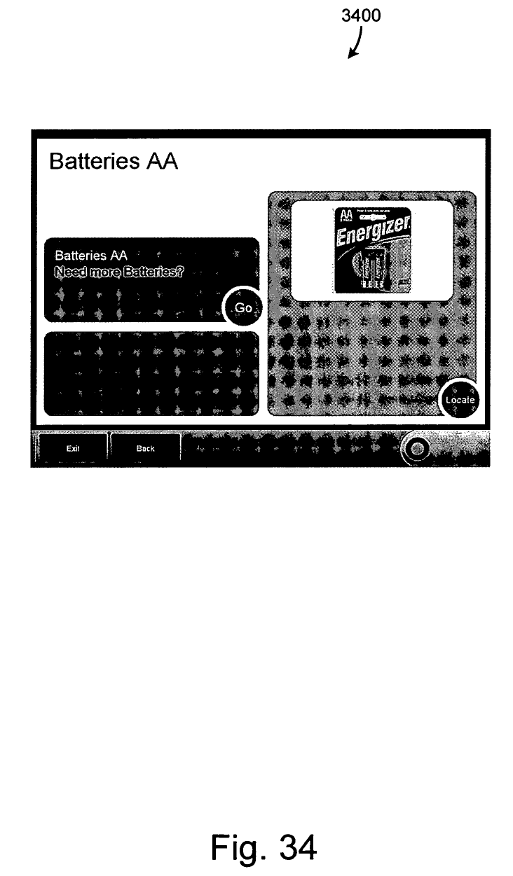

Customers that do not have this personal pricing reward contained within their personal pricing information would not see the message, and therefore not have this reward available for redemption. These customers would see the default item information screen. FIG. 34 illustrates an exemplary screen shot of the default item information screen which may be used in accordance with various embodiments of the present invention.

Once the customer has ended his/her session with the Personal Pricing System Kiosk, they may redeem their rewards at Point of Sale Terminal. If the point of sale system is designated as a “preferred” system, the personal pricing system will be able to transmit the personal pricing information directly to the Point of Sale system in real time. Therefore, the personal pricing promotions would be electronically transferred and be immediately available to the customer. At the Point of Sale terminal, the customer would only be required to identify themselves to receive his/her rewards. No other information would be necessary.

If the system is not a “preferred” system, the personal pricing system would generate a list of personal pricing rewards some (or all) Personal Pricing System Kiosk locations. This list could then be taken to the Point of Sale terminal and be used to indicate the promotions to apply to the customer's purchase.

Conclusion

In conclusion, embodiments of the present invention provide novel systems, methods and arrangements for personalized product promotion. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method comprising:
generating one or more personalized promotional offers, each personalized promotional offer comprising an offer for sale of a product to a customer based on a buying history of the customer; and
making the one or more personalized promotional offers available at a terminal accessed by the customer.

2. The method of claim 1, wherein generating the one or more personalized promotional offers for a customer is anonymous.

3. The method of claim 1, wherein the terminal is an in-store kiosk.

4. The method of claim 1, wherein the terminal is a personal computer.

5. The method of claim 1, further comprising monitoring the buying history of the customer using a unique customer identifier.

6. The method of claim 5, wherein the unique customer identifier is a telephone number.

7. The method of claim 1, further comprising making promotional offers available to the customer when the customer engages in activities available through the terminal.

8. The method of claim 7, wherein the promotional offers comprise one or more additional personalized promotional offers.

9. The method of claim 7, wherein the activities available include one or more interactive games.

10. The method of claim 1, further comprising allowing non-registered users to access the system by using a temporary customer identifier.

11. The method of claim 1, wherein generating the one or more personalized promotional offers is further based on characteristics derived about customers based on the customers' buying histories.

12. A computer-readable storage medium containing a set of instructions capable of causing a processor to:
generate one or more personalized promotional offers, each personalized promotional offer comprising an offer for sale of a product to a customer based on a buying history of the customer; and
make the one or more personalized promotional offers available at a terminal accessed by the customer.

13. The computer-readable storage medium of claim 12, further containing a set of instructions capable of causing a processor to make promotional offers available to the customer when the customer engages in activities available through the terminal.

14. A computer-implemented method comprising:
displaying a first user interface screen on a terminal, the first user interface screen capable of receiving through an input field a unique customer identifier identifying a user of the terminal;
displaying a second user interface screen on the terminal in response to the entry of the unique customer identifier in the input field, the second user interface screen graphically depicting a plurality of promotional offers, the plurality of promotional offers including at least one personalized promotional offer from a plurality of personalized offers; and
displaying a third user interface screen on the terminal that presents an interactive game, playable by the user, wherein the interactive game generates a promotional offer for the user in response to the user playing the interactive game.

15. The computer-implemented method of claim 14, further comprising:
prior to said displaying the second user interface screen, determining which of the personalized promotional offers comprise the at least one personalized promotional offer that are available to the user of the terminal based on the received unique customer identifier;
prior to said displaying the second user interface screen, receiving an indication of the one or more gaming opportunities that are available for interaction with the user of the terminal;
responsive to one or more requests from the user of the terminal, generating a set of one or more promotional offers that may be redeemed at a point of sale center; and
establishing a redemption indicator capable of being used by the point of sale center in order to redeem the set of one or more promotional offers that were generated by the one or more requests from the user.

16. The computer-implemented method of claim 15, wherein the redemption indicator comprises a print version of the one or more promotional offers accepted by the customer which can be redeemed at a point of sale system terminal.

17. The computer-implemented method of claim 15, wherein the redemption indicator comprises an electronic marker which ban be electronically transmitted to a point of sale system and redeemed at a point of sale system terminal.

18. A computer-implemented method comprising:
displaying a first user interface screen on a terminal, the first user interface screen capable of receiving through an input field a unique customer identifier identifying a user of the terminal; and
displaying a second user interface screen on the terminal that presents an interactive game, playable by the user, wherein the interactive game generates a promotional offer for the user in response to the user playing the interactive game.

19. The computer-implemented method of claim 18, further comprising:
prior to said displaying the second user interface screen, determining at least one personalized promotional offer that will be available to the user of the terminal based on the buying history associated with the received unique customer identifier;
prior to said displaying the second user interface screen, receiving an indication interactive gaming opportunities that are available for interaction with the user of the terminal;
responsive to one or more requests from the user of the terminal, generating a set of one or more promotional offers that may be redeemed at a point of sale center; and
establishing a redemption indicator capable of being used by the point of sale center in order to redeem the set of one or more promotional offers that were generated by the one or more requests from the user.

20. A computer-implemented method comprising:
displaying a first user interface screen on a terminal, the first user interface screen capable of receiving through an input field a unique customer identifier identifying a user of the terminal; and
displaying a second user interface screen at the terminal in response to the entry of the unique customer identifier in the input field, the second user interface screen graphically depicting a plurality of promotional offers.

21. The computer-implemented method of claim 20, further comprising:
prior to said displaying the second user interface screen, determining at least one personalized promotional offer that will be available to the user of the terminal based on the buying history associated with the received unique customer identifier;
responsive to one or more requests from the user of the terminal, generating a set of one or more promotional offers that may be redeemed at a point of sale center; and
establishing a redemption indicator capable of being used by the point of sale center in order to redeem the set of one or more promotional offers that were generated by the one or more requests from the user.
